(19) United States
(12) Patent Application Publication
(10) Pub. No.: US 2024/0416756 A1
(43) Pub. Date: Dec. 19, 2024

(54) SAFETY SYSTEMS, DEVICES, AND METHODS FOR IMPROVED ROAD USER SAFETY AND VISIBILITY

(71) Applicant: Spoke Safety, LLC, Denver, CO (US)

(72) Inventors: Jarrett Wendt, Denver, CO (US); Robert Sigety, Milford, MI (US); Angelo Monteleone, Val della Torre (IT); Lutz Kucher, Grahovo (SI); Matthew Austin Maczuzak, Pine, CO (US); David Bartlett, Walnut Creek, CA (US); David Brodie, Penzberg (DE); Domenico Actis Grosso, Torrazza Piemonte (IT); Andrea Tomatis, Sant'Albano Stura (IT)

(21) Appl. No.: 18/726,080

(22) PCT Filed: Jan. 5, 2023
(86) PCT No.: PCT/US23/60172

§ 371 Date: Jul. 1, 2024

Related U.S. Application Data
(60) Provisional application No. 63/384,367, filed on Nov. 18, 2022.
(60) Provisional application No. 63/296,620, filed on Jan. 5, 2022.

(51) Int. Cl. B60L 3/00; H01Q 1/22

(52) U.S. Cl. CPC B60L 3/0015; H01Q 1/2208; B60L 2200/12

(57) ABSTRACT

The present disclosure relates to safety devices and systems for light mobility vehicles. In one example, a safety device for a light mobility vehicle includes a circuit board, one or more connectivity modules coupled to the circuit board, and an antenna coupled to the circuit board. The circuit board may be positioned within or coupled to a light mobility vehicle part. The antenna is configured to mitigate interference of one or more components of the light mobility vehicle part with the one or more connectivity modules.

### CROSS REFERENCE TO RELATED APPLICATIONS

The present patent application claims the benefit of PCT Patent Application No. PCT/US22/24/342, entitled “Data-Driven Autonomous Communication Optimization Safety Systems, Devices, and Methods,” filed on Apr. 12, 2022, U.S. Provisional Patent Application No. 63/384,367, entitled “Safety Systems and Devices for a Light Mobility Vehicle,” filed on Nov. 18, 2022, and U.S. Provisional Patent Application No. 63/296,620, entitled “Data-Driven Autonomous Communication Optimization Safety Systems, Devices, and Methods,” filed on Jan. 5, 2022, the entireties of all of which are hereby incorporated by reference herein for all purposes.

### TECHNICAL FIELD

The technology described herein relates generally to safety systems, devices, and methods, specifically for improved road user safety and visibility.

### BACKGROUND

Light mobility vehicles are becoming increasingly popular means of commuting, exercising, and touring. Light mobility vehicles are typically smaller, lighter weight vehicles, including micromobility vehicles, light electric vehicles, and micro-EVs. For example, light mobility vehicles include bicycles, quadricycles, scooters, skateboards, electric bikes (or Ebikes), electric scooters, electric skateboards, motorcycles, two wheelers, three wheelers, four wheelers, mopeds, and the like. Light mobility vehicles are often driven on the road, which increases the likelihood of collision with automotive vehicles, such as cars, vans, trucks, buses, and the like, and with other light mobility vehicles.

Certain light mobility vehicles have integrated electronics, including controller circuits (e.g., motor controller, switch controller, etc.), battery management systems, and the like. Such electronics, however, do not have connectivity capabilities to connect and communicate with other vehicles on the road. As such, current light mobility vehicles have no visibility of other road users, and vice versa, contributing to road collisions.

The information included in this Background section of the specification, including any references cited herein and any description or discussion thereof, is included for technical reference purposes only and is not to be regarded subject matter by which the scope of the invention as defined in the claims is to be bound.

### SUMMARY

The disclosed technology includes safety systems and devices, specifically for integration and use with a light mobility vehicle. Embodiments of the present disclosure may include a safety device for a light mobility vehicle. The safety device may include a circuit board, one or more connectivity modules coupled to the circuit board, and a battery management system coupled to the circuit board and configured to couple to battery cells of a light mobility vehicle battery. Additionally or separately, the one or more connectivity modules may include a C-V2X chip. Additionally or separately, the one or more connectivity modules may include a cellular modem.

Additionally or separately, the safety device may include a specialized antenna coupled to the circuit board. The specialized antenna may be configured to mitigate interference of components of the light mobility vehicle battery with the one or more connectivity modules. Additionally or separately, the safety device may include one or more sensors coupled to the circuit board. Additionally or separately, the safety device may include a shield positioned around a portion of the one or more connectivity modules. The shield may be configured to minimize interference between the safety device and the light mobility vehicle battery.

Other examples or embodiments of the present disclosure may include a battery for a light mobility vehicle. The battery may include a battery housing having a battery housing cavity, a first connectivity module positioned inside the battery housing cavity, and one or more battery cells positioned inside the battery housing cavity and coupled to the first connectivity module to provide power to the first connectivity module. The first connectivity module may be configured to communicate with a compatible other connectivity module that is separate from the light mobility vehicle.

Additionally or separately, the first connectivity module may be coupled to a printed circuit board, and the battery may include a battery management system coupled to the printed circuit board and to the one or more battery cells. Additionally or separately, the first connectivity module may include a C-V2X chip. Additionally or separately, the first connectivity module may include a cellular modem. Additionally or separately, the battery may include a second connectivity module positioned inside the battery housing cavity. The second connectivity module may include a cellular modem. Additionally or separately, the battery may include an LDS antenna coupled to an external surface of the battery housing. Additionally or separately, the battery may include a GPS sensor coupled to the connectivity module and the LDS antenna. Additionally or separately, the GPS sensor may be positioned inside the battery housing and proximate a top wall of the battery housing.

Further examples or embodiments of the present disclosure may include a safety system for a light mobility vehicle. The safety system may include a power source; a connectivity module coupled to the power source and configured to communicate with a compatible second connectivity module that is separate from the light mobility vehicle; a display coupled to a handlebar component of the light mobility vehicle; a GNSS sensor coupled to the display; and a power supply line coupling the power source to the display to power the display. The GNSS sensor may transmit a GNSS signal via the power supply line to the connectivity module.

Additional examples or embodiments of the present disclosure may include a method of using a power cable to transmit a communication signal. The method may include receiving, by a GNSS sensor coupled to a first end of a power cable, a GNSS signal; and transmitting, by the power cable, the GNSS signal to a C-V2X chip coupled to a second end of the power cable. The power cable may be coupled to a light mobility vehicle. Additionally or separately, the C-V2X chip may be coupled to a power source of the light mobility vehicle.

Further examples or embodiments of the present disclosure may include a safety device for a light mobility vehicle. The safety device may include a circuit board positioned within or coupled to a light mobility vehicle part; one or more connectivity modules coupled to the circuit board; and a specialized antenna coupled to the circuit board, wherein the specialized antenna is configured to mitigate interference of one or more components of the light mobility vehicle part with the one or more connectivity modules. Additionally or separately, the one or more connectivity modules may include a C-V2X chip. Additionally or separately, the one or more connectivity modules may include a cellular modem. Additionally or separately, the light mobility vehicle part may be a battery. Additionally or separately, the safety device may include a battery management system coupled to the circuit board and configured to couple to battery cells of the battery. Additionally or separately, the safety device may include one or more sensors coupled to the circuit board. Additionally or separately, the safety device may include a shield positioned around a portion of the one or more connectivity modules, the shield configured to minimize interference between the safety device and the light mobility vehicle part. Additionally or separately, the light mobility vehicle part may be a controller.

Further examples or embodiments of the present disclosure may include a battery system for a light mobility vehicle. The battery system may include a battery housing having a battery housing cavity; a first connectivity module positioned inside the battery housing cavity, the first connectivity module configured to communicate with a compatible other connectivity module that is separate from the light mobility vehicle; and one or more battery cells positioned inside the battery housing cavity and coupled to the first connectivity module to provide power to the first connectivity module. Additionally or separately, the first connectivity module may be coupled to a printed circuit board, and the battery system may include a battery management system coupled to the printed circuit board and to the one or more battery cells. Additionally or separately, the first connectivity module may include a C-V2X chip. Additionally or separately, the first connectivity module may include a cellular modem. Additionally or separately, a second connectivity module may be positioned inside the battery housing cavity. The second connectivity module may include a cellular modem. Additionally or separately, the battery system may include an LDS antenna coupled to an external surface of the battery housing. Additionally or separately, the battery system may include a GNNS sensor coupled to the first connectivity module and the LDS antenna. Additionally or separately, the GNNS sensor may be positioned inside the battery housing and proximate a top wall of the battery housing.

Further examples or embodiments of the present disclosure may include a safety system for a light mobility vehicle. The safety system may include a power source; at least one connectivity module coupled to the power source and configured to communicate with at least one compatible second connectivity module that is separate from the light mobility vehicle; a display coupled to a handlebar component of the light mobility vehicle; a GNSS sensor coupled to the display; and a power supply line coupling the power source to the display to power the display. The GNSS sensor may transmit a GNSS signal via the power supply line to the connectivity module. Additionally or separately, the at least one connectivity module may include at least one of a C-V2X chip and a cellular modem. Additionally or separately, the safety system may include a local processing element in communication with the at least one connectivity module, wherein the local processing element is configured to assess a threat based on the GNSS signal received and entity data received by the at least one connectivity module from the at least one compatible second connectivity module.

Further examples or embodiments of the present disclosure may include a method of using a power cable to transmit a communication signal. The method may include receiving, by a GNSS sensor coupled to a first end of a power cable, a GNSS signal; and transmitting, by the power cable, the GNSS signal to a C-V2X chip coupled to a second end of the power cable; wherein the power cable is coupled to a light mobility vehicle. Additionally or separately, the C-V2X chip may be coupled to a power source of the light mobility vehicle.

Further examples or embodiments of the present disclosure may include a method of transmitting alerts of oncoming light mobility vehicles when an automotive vehicle is traveling. The method may include receiving, by an automotive vehicle connectivity device, entity data related to a light mobility vehicle from a safety device coupled to the light mobility vehicle, wherein the safety device includes a connectivity module compatible with the automotive vehicle connectivity device; transmitting, to an automotive vehicle processor, the entity data; receiving, by the automotive vehicle processor, automotive vehicle sensor data from one or more automotive vehicle sensor devices; comparing, by the automotive vehicle processor, the entity data and the automotive vehicle sensor data to determine a threat, wherein the threat is a high risk that a trajectory of the light mobility vehicle and a trajectory of the automotive vehicle will intersect resulting in a collision; and transmitting, by the automotive vehicle processor, an alert to a graphical user interface of an automotive vehicle display based on the determined threat. Additionally or separately, the automotive vehicle sensor data may include one or more of turn signal data, brake data, acceleration data, or wheel angle data. Additionally or separately, the connectivity module of the safety device may include a C-V2X chip. Additionally or separately, the connectivity module of the safety device may include a cellular modem and the entity data may be received from a server in communication with the automotive vehicle connectivity device. Additionally or separately, the alert may be heightened when the threat is imminent. Additionally or separately, the method may include transmitting, by the automotive vehicle processor, a brake signal to an automatic emergency braking system of the automotive vehicle when the threat is imminent.

Further examples or embodiments of the present disclosure may include a method of manufacturing a safety device for a light mobility vehicle. The method may include coupling one or more connectivity modules to a circuit board, wherein the one or more connectivity modules are configured to transmit entity data to a nearby entity having a compatible connectivity module; coupling one or more sensors to the one or more connectivity modules; positioning the circuit board inside a housing, wherein the housing is a light mobility vehicle battery housing of a light mobility vehicle battery or a safety device housing configured to couple to a component of a light mobility vehicle; and coupling an antenna to an external surface of the housing, wherein the antenna is coupled to the one or more sensors and is configured to reduce signal interference from the light mobility vehicle battery or the component. Additionally or separately, the one or more connectivity modules may include a C-V2X chip. Additionally or separately, the one or more sensors may include a GNNS sensor. Additionally or separately, the method may include coupling the one or more sensors to the circuit board. Additionally or separately, coupling the one or more sensors to the one or more connectivity modules may include coupling the one or more sensors to the one or more connectivity modules by a power cable of the light mobility vehicle. Additionally or separately, coupling the one or more sensors to the one or more connectivity modules may include coupling the one or more sensors wirelessly to the one or more connectivity modules.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

FIG. 1 is a block diagram illustrating an example of a data-driven autonomous communication optimization safety system.

FIG. 2 is a simplified block diagram of an exemplary safety device that can be used with the system of FIG. 1.

FIG. 3 is a simplified block diagram of an exemplary connectivity module of the safety device of FIG. 2.

FIG. 4 is an image of an exemplary safety device that can be used with the system of FIG. 1.

FIG. 5 is a simplified diagram of exemplary safety device hardware architecture of a safety device that can be used with the system of FIG. 1.

FIG. 6 is an illustration of short-distance range and long-distance range capabilities of the system of FIG. 1.

FIGS. 7A-B show a diagram of exemplary safety device hardware architecture of a safety device that can be used with the system of FIG. 1.

FIG. 8 is a simplified diagram of exemplary dedicated user device hardware architecture of a user device that can be used with the system of FIG. 1.

FIGS. 9A-B show a diagram of exemplary dedicated user device hardware architecture of a user device that can be used with the system of FIG. 1.

FIG. 10 is an image of an exemplary sensor device that can be used with the system of FIG. 1.

FIGS. 11A-B are images of an exemplary sensor device that omits a camera and can be used with the system of FIG. 1.

FIG. 12 is a simplified diagram of exemplary sensor device hardware architecture of a sensor device that can be used with the system of FIG. 1.

FIG. 13 is a diagram of exemplary sensor device hardware architecture of a sensor device that can be used with the system of FIG. 1.

FIG. 14 is an image of an exemplary positioning of the sensor device of FIGS. 11A-B on a bicycle.

FIG. 15 is a simplified block diagram of a safety light mobility vehicle.

FIGS. 16A-F are images of exemplary safety device positioning relative to safety bicycles and their components.

FIG. 17 is a side view of a light mobility vehicle that incorporates a connected power source.

FIG. 18 is an isometric view of the connected power source of FIG. 1 and an exploded isometric view of the same.

FIG. 19 is a side view of a light mobility vehicle with an integrated safety system.

FIG. 20 is a top plan view of an exemplary safety device.

FIG. 21A-B are images of an exemplary controller that incorporates safety device components.

FIG. 22 is an image of an exemplary micromobility vehicle safety system integrated with a bicycle.

FIG. 23 is a simplified block diagram of a light mobility vehicle safety system that can be integrated with a light mobility vehicle.

FIGS. 24A-C are images showing automotive vehicle graphical user interfaces displaying safety-related data.

FIGS. 25A-D are images showing an automotive vehicle dashboard displaying safety-related alerts.

FIG. 26 is a simplified block diagram of a computing device that can be used by one or more components of the system of FIG. 1.

FIG. 27 is a simplified block diagram of a safety system of a motor vehicle.

FIG. 28 is a flow chart illustrating a method of manufacturing a disclosed safety device.

FIG. 29 is a flow chart illustrating a method of using a light mobility vehicle power cable to transmit a communication signal.

FIG. 30 is a flow chart illustrating a method of transmitting alerts of oncoming light mobility vehicles when a vehicle is traveling.

### DETAILED DESCRIPTION

The disclosed technology includes safety systems, devices, and methods, specifically for improved road user safety and visibility. In several embodiments, disclosed safety devices are coupled to or otherwise integrated with a light mobility vehicle. In several embodiments, safety devices, systems, and methods incorporate safety-related data related to a light mobility vehicle, including its position, heading, speed, acceleration/deceleration, trajectory, and the like. By incorporating light mobility vehicle safety-related data, disclosed safety devices, systems, and methods increase visibility between light mobility vehicles and other road users. Embodiments of the present disclosure may include one or more of the safety devices, dedicated user devices, and sensor devices, and/or one or more of their components, disclosed in PCT Patent Application No. PCT/US22/24/342, entitled “Data-Driven Autonomous Communication Optimization Safety Systems, Devices, and Methods,” filed on Apr. 12, 2022 (the “PCT Application”), the entire contents of which are hereby expressly incorporated by reference.

Disclosed safety systems, devices, and methods improve safety and visibility for road users, which include light mobility vehicles, automotive vehicles, and pedestrians. As used herein, light mobility vehicles include micromobility vehicles, which includes, for example, electronic and non-electronic bicycles, pedal assisted bicycles, electric and non-electric scooters, electric and non-electric skateboards, electric and non-electric unicycles, electric and non-electric tricycles, electric and non-electric quadricycles, and the like. Light mobility vehicles also include motorcycles, e-motorcycles, two wheelers, three wheelers, four wheelers, ATVs, mopeds, light electric vehicles (EV), micro-EV, and the like. As used herein, automotive vehicles refer to vehicles other than light mobility vehicles, including, for example, cars, vans, trucks, buses, and the like.

The present disclosure relates to the integration of safety systems and devices with light mobility vehicles and the application of safety-related data collected and transmitted by such integrated safety systems and devices, which has not been previously available. Safety-related data may include data that relates to safety risks and/or real-time circumstances, conditions, and/or situations, including those that may pose a threat to a road user's safety.

Safety-related data may include entity data (e.g., Basic Safety Messages, such as SAE J2735, location, proximity, speed/velocity, acceleration, deceleration, heading, distance, path/route/trajectory, movement changes, etc. related to entities or road users, including light mobility vehicles, automotive vehicles, pedestrians, etc.), SAE deployment profiles (e.g., related to blind spot detection, right turn assist, left turn assist, do not pass, etc.), personal safety messages (PSM), time, power (e.g., battery life of safety device and/or light mobility vehicle), sensor data, collisions and collision risk, road/surface conditions (e.g., elevation changes, turns, surface type, surface state, etc.), road/surface hazards or obstacles (e.g., potholes, traffic cones, bumps, etc.), traffic or congestion, weather (including weather probabilities and expected times of weather events), environment (e.g., altitude, air quality, heat index, humidity, temperature, visibility, etc.), traffic intersections, traffic lights, traffic signs (e.g., speed limit signs, stop signs, warning signs, etc.), laws or ordinances, criminal activity (including locations and time of day), user data (e.g., biometrics, health, age, weight, height, gender, energy exertion, fitness and/or wellness goals, etc.), vehicle data (e.g., type, size, age, condition, etc.), and the like. As used herein, safety may encompass physical safety (e.g., collision avoidance), mental/emotional well-being (e.g., crime avoidance), health (e.g., maintaining safe heart rate/blood pressure levels, limiting exposure to toxins, etc.), vehicle safety (e.g., safe maintenance/condition for risk prevention), and the like. Safety-related data may be exchanged between one or more entities, which include light mobility vehicles, automotive vehicles, user devices (e.g., held by pedestrians), and infrastructure.

### Systems Overview

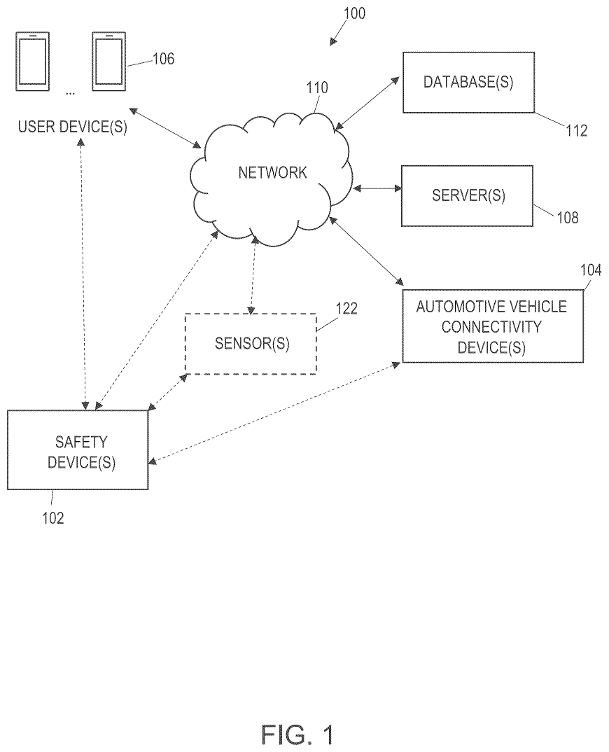

Turning now to the figures, systems of the present disclosure will be discussed in more detail. FIG. 1 is a block diagram illustrating an example of a safety system 100. The system 100 may include one or more safety devices 102, which are described in greater detail below. As discussed below, the one or more safety devices 102 may include one or more connectivity devices. The one or more safety devices 102 may be coupled to or otherwise integrated with a light mobility vehicle and/or an automotive vehicle (e.g., placed in a glove compartment), as described in more detail below. It is also contemplated that the one or more safety devices 102 may be portable (e.g., carried by a pedestrian).

The one or more safety devices 102 may be in communication with each other and/or with one or more automotive vehicle connectivity devices or modules 104. The one or more automotive vehicle connectivity devices or modules 104 may include connectivity devices compatible with the one or more connectivity devices of the one or more safety devices 102, such as, for example a V2X chipset or modem (e.g., a C-V2X chip), a Wi-Fi modem, a Bluetooth modem (BLE), a cellular modem (e.g., 3G, 4G, 5G, LTE, or the like), ANT+ chipsets, and the like. The one or more safety devices 102 may be in communication with the one or more automotive vehicle connectivity devices 104 directly (e.g., between two C-V2X chips) or indirectly, e.g., via one or more servers or remote processing elements 108, via a network 110 (e.g., between two LTE modems).

In some embodiments, the safety device(s) 102 are in communication with one or more user devices 106, which in turn are in communication with one or more servers or remote processing elements 108, via a network 110. The one or more user devices 106 may include various types of computing devices, e.g., smart phones, smart displays, tablet computers, desktop computers, laptop computers, set top boxes, gaming devices, wearable devices, ear buds/pods, or the like. The one or more user devices 106 provide output to and receive input from a user (e.g., via a human-machine interface or HMI). The one or more user devices 106 may receive one or more alerts, notifications, or feedback from one or more of the one or more servers 108, the one or more sensors 122, the one or more safety devices 102, and the one or more automotive vehicle connectivity devices 104 indicative of safety-related information (e.g., safety-related data described herein, such as relative positions/locations of other entities and/or collision-related or traffic-related data). The type and number of user devices 106 may vary as desired.

The one or more user devices 106 may include a dedicated user device that is associated with a safety device described herein or functions in a similar manner as a safety device described herein. The dedicated user device may include safety application software configured to execute one or more of the methods described herein and described in the PCT Application. In some embodiments, by incorporating a dedicated user device (e.g., instead of a traditional user device such as a smartphone), the safety system 100 can provide more direct and efficient safety output to a user. For example, the dedicated user device may exclude other applications that can interfere with the transmission of safety messages to ensure that safety messages are timely and effectively transmitted to a user. A dedicated user device may provide a higher level of safety and reliability than a smartphone or tablet that integrates other applications and non-safety related data.

In some embodiments, the safety device(s) 102 and automotive vehicle connectivity device(s) 104 are in communication with one or more servers 108, via network 110, which in turn may be in communication with one or more user devices 106. The one or more servers 108 may be in communication with one or more databases 112, via network 110. Each of the various components of the safety system 100 may be in communication directly or indirectly with one another, such as through the network 110. In this manner, each of the components can transmit and receive data from other components in the system 100. In many instances, the one or more servers 108 may act as a go between for some of the components in the system 100.

The one or more servers 108 may include remote processing element(s) configured to process safety-related data. The one or more servers 108 may collect, transmit, and/or store safety-related data to and from one or more safety devices 102, sensors 122, automotive vehicle connectivity device(s) 104, user device(s) 106, and database(s) 112. In some embodiments, the one or more servers 108 transmit, via the network 110, the safety-related data to one or more safety devices 102 and/or to one or more automotive vehicle connectivity devices 104.

The one or more databases 112 are configured to store information related to the systems and methods described herein. The one or more databases 112 may include one or more internal databases storing data collected or determined by the system, such as, for example, safety-related data, safety threat or action data, trend data, and the like. As discussed, safety-related data may include, for example, entity data, vehicle data, safety device data, user data, environmental data, sensor data, collision-related data, traffic data, road/surface condition data, and the like, as discussed in more detail below.

The one or more databases 112 may include third-party databases, such as for example, those linked to third-party applications that collect entity data, such as fitness wearables (e.g., Fitbit, Halo, Apple, etc.), training applications (e.g., Under Armor, Strava, TrainingPeaks, etc.), navigational applications (e.g., Apple Maps, Waze, etc.), cycling applications (e.g., Ride GPS, Bike2Peak, etc.), and the like, and/or third-party databases storing safety-related data, such as data related to the environment (e.g., air quality index, heat index, topography, altitude, humidity, temperature, visibility, etc.), weather, traffic, accidents, traffic intersections or signs, laws or ordinances, and the like. For example, road/surface data, collision data, road construction data, or the like may be received from a Department of Transportation database. As another example, traffic data and intersection data may be received from an Iteris database. As yet another example, map and location data, including elevation data, may be received from a Mapbox database or API.

In some embodiments, the system 100 may include one or more sensors 122. The sensor data collected by the one or more sensors 122 may be included in the safety-related data described herein. For example, the one or more sensors 122 may collect data related to position, motion, speed, heading, trajectory, pressure, contact, environment, weather, object detection, and the like. For example, the one or more sensors 122 may include one or more accelerometers, position sensors (e.g., GPS, GNSS, or the like), motion detectors, haptic sensors, gyroscopes, heading sensors, cameras, infrared sensors, microphones, radars, light sensors, light detection and radars (LIDAR), speed sensors, pressure sensors (e.g., piezoresistive sensor, barometers, etc.), power or energy sensors, thermal sensors, biometric sensors (e.g., heart rate sensors, etc.), odor or air quality sensors (e.g., an electronic nose), and the like. It is contemplated that the one or more sensors may be separate or included in the same sensor device. For example, the one or more sensors may be part of an inertial measurement unit (IMU), which may be configured to measure angular rate, force, magnetic field, and/or orientation. For example, an IMU includes an accelerometer and gyroscope and may also include a magnetometer. It is contemplated that the system 100 may have multiple of the same sensors 122. For example, the system 100 may include multiple cameras for sensing objects (and their proximity, location, motion, acceleration, and/or deceleration, etc.) from multiple angles. For example, a light mobility vehicle may have one or more of a front-facing camera, a rear-facing camera, and one or more side-facing (left or right) cameras, and/or a user may have a helmet camera or other body camera. It is contemplated that the one or more sensors 122 may include third-party sensors used by third-party systems that are in communication with the system 100 (e.g., Iteris infrastructure sensors, traffic/intersection cameras, car cameras, etc.). The one or more sensors 122 may be part of a sensor device that is separate from the safety device(s) 102.

The network 110 may be substantially any type or combination of types of communication systems or modes for transmitting data either through wired or wireless mechanism (e.g., Wi-Fi, Ethernet, Bluetooth, ANT+, cellular data, radio frequencies, or the like). In some embodiments, certain components of the safety system 100 may communicate via a first communication system or mode (e.g., cellular) and others may communicate via a second communication system or mode (e.g., Wi-Fi or Bluetooth). Additionally, certain components may have multiple transmission mechanisms and may be configured to communicate data in two or more manners. The configuration of the network 110 and communication mechanisms for each of the components may be varied as desired and based on the needs of a particular location.

### Safety Devices

As described in more detail in the PCT Application, a disclosed safety device may include a safety device housing and one or more connectivity devices or modules positioned inside the safety device housing. The one or more connectivity devices or modules enable the safety device to exchange entity data (e.g., location, speed, heading, acceleration, etc.) with one or more connectivity devices of one or more other entities (e.g., an automotive vehicle connectivity device or other safety device), thereby increasing contextual awareness between the entities.

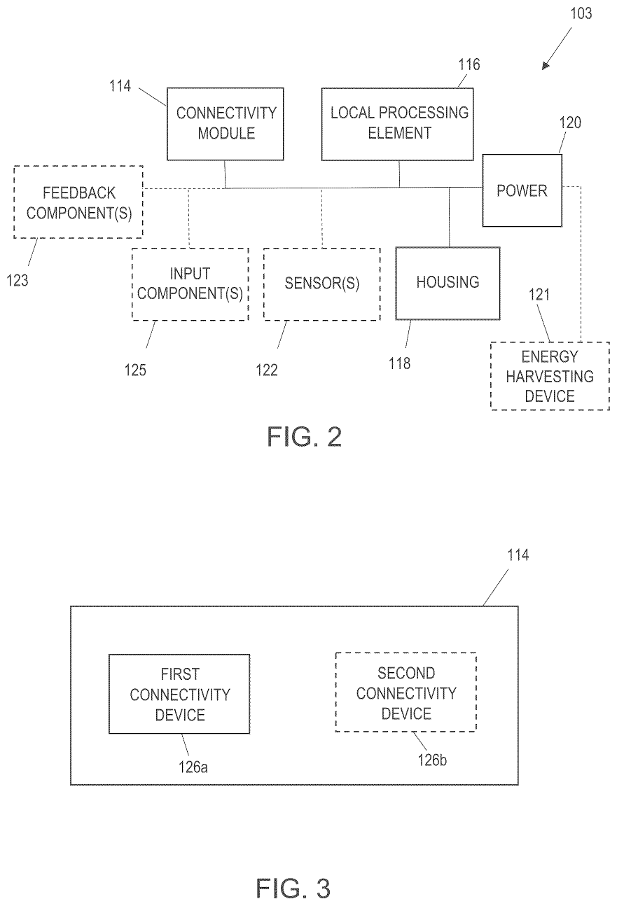

FIG. 2 is a simplified block diagram of an exemplary safety device 103 that can be used with the system of FIG. 1. As shown, the safety device 103 may include a housing 118, a connectivity module 114, a local processing element 116, and a power source 120. In several embodiments, the connectivity module 114 transmits and receives safety-related data to and from other entities (e.g., other safety device(s) 102 and/or automotive vehicle connectivity device(s) 104).

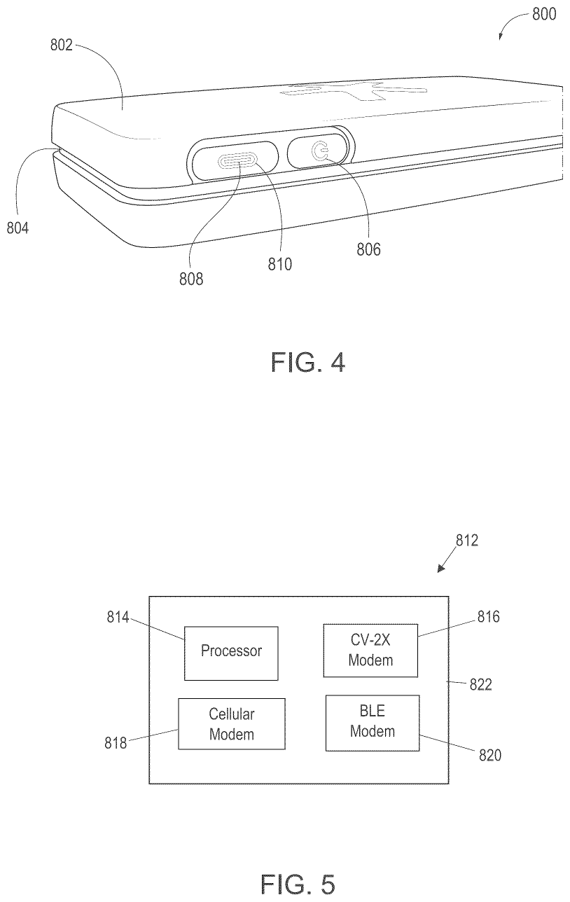

FIG. 3 is a simplified block diagram of an exemplary connectivity module 114. As shown, the connectivity module 114 may include one or more connectivity devices or modules 126a,b, such as a first connectivity device or module 126a and a second connectivity device or module 126b. The one or more connectivity devices or modules 126a,b may include a V2X chipset or modem (e.g., a C-V2X chip), a Wi-Fi modem, a Bluetooth modem (BLE), a cellular modem (e.g., 3G, 4G, 5G, LTE, or the like), an ANT+ chipset, and the like.

Returning to FIG. 2, the connectivity module 114 may be coupled to a local processing element 116 and positioned inside the safety device housing 118. The safety device housing 118 may be compact or minimized to minimize weight and bulkiness of the safety device 103 on a light mobility vehicle. In some embodiments, the safety device housing 118 is omitted, for example, when the safety device is positioned inside a battery housing or other light mobility component housing, as discussed in more detail below. In some embodiments, the local processing element 116 is omitted and processing of safety-related data is executed by an external processor (e.g., server 108). In some embodiments, the safety device 103 may include more than one processing element. In these embodiments, the processing elements may or may not be in communication with one another.

The local processing element 116 may receive safety-related data (e.g., from the connectivity module 114) and determine whether the safety-related data is relevant or poses a threat. For example, a threat may be detected if the local processing element 116 determines trajectories of two entities will cross causing a collision. For example, if the trajectory of the road user of the safety device is straight and an entity is projected to turn right, the processing element may detect a threat and transmit an alert. As an example, the entity's right turn data may be received from a car sensor detecting a car blinker right turn signal.

In the depicted embodiment, the safety device 103 includes a power source 120. The power source 120 may be a battery. For example, the battery may be a lithium ion battery. The battery may have a 7 to 14 hour run time. The battery may include a battery save mode to conserve power. The power 120 may be turned on by a power on button on an outer surface of the housing 118 of the safety device 103. In some embodiments, the power source 120 may be omitted and the safety device 103 may be powered by an external power source. For example, the safety device 103 may be powered by an electronic battery of an electric light mobility vehicle, as discussed in more detail below.

In some embodiments, the safety device 103 may include an energy harvesting or scavenging device 121. Energy harvesting also known as power harvesting or energy scavenging is a process by which energy is captured and stored. Energy harvesting makes it possible to drive an electrical system without the necessity of a stored power source, such as a battery, or to replenish the power source to drive the electrical system. Energy harvesting systems conventionally use thermal electricity or mechanical vibrations which are converted to electric energy. The energy harvesting device 121 may be coupled to the power source 120. The energy harvesting device 121 may create electrical power output to replenish electrical power stored by the power source 120. The energy harvesting device 121 may capture energy from light, vibration, thermal (e.g., from exhaust), mechanical (e.g., from rotation of light mobility vehicle tires or pedals), piezoelectric, electromagnetic, triboelectric, or biological sources and convert the energy into electricity to power the safety device 103 and its components or to provide additional power to the power source 120. The energy harvesting device 121 may include, for example, one or more photovoltaic or solar cells, piezoelectric devices, electromagnetic devices, triboelectric devices, and the like.

The energy harvesting device 121 may include components that are part of a charging circuit that includes the power source 120. In response to a motive force applied to at least one of the components, the components may interact with one another to generate electrical power. The electrical power may be transferred via the charging circuit to replenish the electrical power stored within the power source 120. As one example, the energy harvesting device 121 may include a coil containing a floating mass that vibrates to generate energy. For example, an electrical coil may include one or more linearly moving or rotating magnets positioned within an inner passage of the coil. In operation, as the safety device 103 moves or shakes (e.g., via movement of the light mobility vehicle it is coupled to), the one or more magnets may move through the coil inner passage or rotate/spin via a rotational axle (e.g., due to airflow through the coil), creating a current along the windings of the electrical coil, which can be converted into stored electrical power. An electrically conductive material may be provided between the electrical coil and the power source 120, creating a charging circuit to replenish electrical energy within the power source 120. It is contemplated that a plurality of magnets may move or rotate within the inner passage of the coil. The magnets may be arranged with like polarities oriented in a like direction causing the magnets to move in opposite directions. Similarly, the magnets may be arranged with like polarities oriented in opposite directions causing the magnets to move in parallel to each other.

In some embodiments, the energy harvesting device 121 may generate electrical power by harvesting mechanical energy. For example, the energy harvesting device 121 may include components that generate electrical energy from rotational motion. For example, a component may be biased against a wheel of the light mobility vehicle and may rotate based on rotation of the wheel. The component may rotate other components of the energy harvesting device 121 to generate electrical energy. For example, one of the components may be coupled to electrical contacts connected to a cable that is connected to the safety device 103 or its components and transfer the electrical energy, via the electrical contacts, through the cable to the safety device 103 or its components.

The energy harvesting device 121 may extend the life of the power source 120. This may be particularly beneficial where the safety device 103 is integrated into the frame of a light mobility vehicle or otherwise coupled to the light mobility vehicle in a manner that presents challenges to charging or replacing the safety device 103. It is contemplated that the energy harvesting device 121 may be coupled to the safety device 103 housing 118 (e.g., a solar cell on an external surface of the housing 118) or may be positioned inside the housing 118. In some embodiments, the energy harvesting device 121 is omitted from the safety device 103. The energy harvesting device 121 may be a separate device coupled to the safety device 103. For example, the energy harvesting device 121 may be positioned on a separate component of a light mobility vehicle apart from the safety device 103 (e.g., on a tire, a pedal, an exhaust pipe, handlebars, a frame component, a seat post, etc.). It is contemplated that the energy harvesting device 121 may provide power directly to components of the safety device 103 (e.g., in addition to the power source 120 or if the power source 120 is omitted). For example, the energy harvesting device 121 may provide power to the one or more sensors 122.

As shown, the one or more sensors 122 may be integrated with the safety device 103. The one or more sensors 122 may include, for example, one or more accelerometers, position sensors (e.g., GPS, GNSS, or the like), motion detectors, ultrasonic sensors, jolt sensors, haptic sensors, gyroscopes, heading sensors, orientation sensors (e.g., a magnetometer), altimeters, cameras, infrared sensors, microphones, radars, light sensors, light detection and radars (LIDAR), SONAR/ultrasound sensors, speed sensors, hall effect sensors, pressure sensors (e.g., piezoresistive sensors, barometers, etc.), power or energy sensors, thermal or temperature sensors, biometric sensors (e.g., heart rate sensors, etc.), odor or air quality sensors (e.g., an electronic nose), advance driver assistance system (ADAS) sensors, and the like. ADAS sensors may include sensors that provide data related to surround view, park assist, blind spot detection, rear collision warning, cross traffic alert, traffic sign recognition, lane departure warning, emergency braking, collision avoidance, pedestrian detection, adaptive cruise control, and the like. As a non-limiting example, the safety device may include a C-V2X chip in communication with one or more GPS sensors. It is contemplated that the one or more sensors 122 may be separate from the safety device 103 and in communication with the connectivity module 114. For example, the safety device 103 may pair with one or more sensors 122, e.g., with one or more cameras, via a communication protocol (e.g., BLE). It is contemplated that the one or more sensors 122 may be combined into a single sensor device. As an example, a single sensor device may include an accelerometer, magnetometer, gyroscope, altimeter, and/or temperature sensor. The one or more sensors 122 may enable the safety device 103 to detect position, velocity/speed, trajectory, heading/orientation, and the like.

In some embodiments, the safety device 103 includes one or more feedback components 123 (also referred to as an output device herein) for providing feedback to a user, e.g., alerts of safety risks and/or safe actions, including, for example, collision probability or proximity, distance, path, etc. of other entities. The one or more feedback components 123 may provide feedback to the user of the safety device 103 or to other users. The one or more feedback components 123 may include components configured to provide visual, haptic, and/or audible feedback. For example, the one or more feedback components 123 may include one or more of a display/GUI, light/LED, haptic device, sound device/speaker, indicator (e.g., battery charge indicator), reflector, and the like. As an example, a speaker may be acoustically tuned and provide directional audio. The one or more feedback components 123 may vary based on the direction of a threat. For example, a light may flash on or a sound may be emitted from a left side of the safety device 103 to indicate a threat from the left and a light may flash on or a sound may be emitted from a right side of the safety device 103 to indicate a threat from the right.

The one or more feedback components 123 or output devices may operate in a feedback loop, where the feedback output by these components may be adjusted or otherwise modified. For example, an alert may be transmitted by the one or more feedback components 123 indicating a threat. The one or more feedback components 123 may receive user input (e.g., via a user pressing a button) indicating the threat is incorrect or no longer present. The one or more feedback components 123 may turn the alert off or otherwise remove the alert based on the user input. Additionally or alternatively, the one or more feedback components 123 may receive safety-related data from the one or more sensors 122 or the connectivity module 114 and may override user input and keep the alert on or re-transmit the alert.

As another example, the one or more feedback components 123 may receive safety-related data from the one or more sensors 122 or the connectivity module 114 and determine that the threat is mitigated or gone and remove the alert based on the safety-related data. For example, the one or more feedback components 123 may receive a braking signal from a brake sensor indicating that the rider is braking and determine that the threat is mitigated or gone. As another example, the one or more feedback components 123 may receive sensor data (e.g., image data from a camera) and determine that the threat is gone and remove the alert. As yet another example, the connectivity module 114 may no longer receive entity data (e.g., because the entity is out of range of the C-V2X modem) and may transmit this information to the one or more feedback components 123, which determine that the threat is gone and remove the alert. While the above examples are discussed with respect to the feedback components 123, it is contemplated that the local processing element 116 may perform the logic (e.g., receiving user input or safety-related data and determining a threat is mitigated or gone) and transmit a signal to the feedback components 123 to turn off or remove the alert.

In some embodiments, the safety device 103 includes one or more input components 125 that enable a user to provide input to or to control the safety device 103. For example, the one or more input components 125 may include one or more of a display/GUI, a microphone, buttons (e.g., power on button), switches, remote controls, charging ports (e.g., USB charging ports), and the like. For example, the display may be a capacitive or resistive touch screen, or may include both capacitive and resistive elements. As an example, a resistive touch screen may allow the display to be used with a glove. As another example, a microphone may be acoustically tuned and include noise cancelling functionality.

It is contemplated that the one or more input components 125 or feedback components 123 may be separate from the safety device 103 and in communication with the safety device 103 (e.g., the local processing element 116) (e.g., a light in communication with the safety device 103, a display on a user device, third-party devices such as ear buds or smartwatches, haptic feedback elements integrated into a light mobility vehicle component such as handlebars, seat, helmet, etc.). For example, the safety device 103 may pair with one or more feedback components, e.g., an external display, via a communication protocol (e.g., BLE). In some embodiments, the one or more input components 125 and/or one or more feedback components 123 are coupled to a dedicated user device and/or sensor device described herein.

In several embodiments, one or more safety device components are coupled to one or more printed circuit boards (PCBs). For example, one or more of the one or more connectivity modules, the one or more processors, and the one or more sensors may be coupled to one or more PCBs. The one or more printed circuit boards may include one or more antennas for transmitting signals from and to the one or more connectivity modules and/or from and to the one or more sensors. It is contemplated that the one or more antennas may be separate from the one or more PCBs and in communication with the one or more connectivity modules and/or the one or more sensors (e.g., via wired or wireless connections). The one or more antennas may include commercial off-the-shelf (COTS) antennas, Laser Direct Structuring (LDS) antennas, GNSS antennas (e.g., GPS antennas), LTE antennas, BLE antennas, C-V2X antennas, Wi-Fi antennas, and the like. An antenna described herein may be a specialized antenna. A specialized antenna is any antenna used with the safety device that is modified for this specific application. For example, the antenna may be modified in some way, including modifications to its shape, size, location, sturdiness, durability, and the like. For example, an antenna may be reduced in size to fit the form factor of the safety device. The one or more printed circuit boards may further include the safety device processor coupled to the one or more connectivity modules. It is contemplated that the components of the safety device may be positioned on one printed circuit board or on a plurality of printed circuit boards that are wired or wirelessly connected. It is contemplated that the components of the safety device may be wirelessly connected by various means, including for example LORA, UWB, ZigBee, Matter, and Bluetooth.

The safety device components may be coupled to one another by various connectors or buses. For example, safety device components may be coupled to one another by a Controller Area Network (CAN) bus. Safety device components may be coupled by wires, cables, wirelessly, etc. As discussed below, safety device components may be coupled by a power cable associated with an electric light mobility vehicle battery.

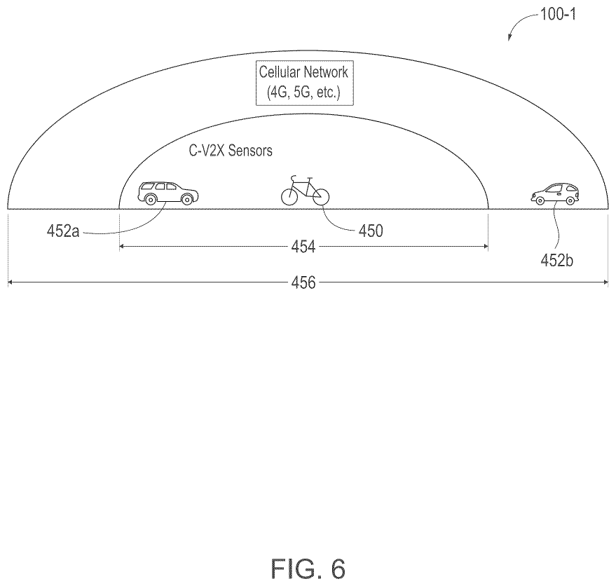

FIG. 4 shows an image of an exemplary safety device 800. As shown, the safety device 800 includes a housing 802, a light 804, an ON/OFF button 806, and a power input 808. The housing 802 has a rectangular-shaped form factor. The light 804 is recessed in the housing 802. As shown, the light 804 is recessed around the sides of the housing 802. For example, the light 804 may be an LED strip. The light 804 may be selectively turned on and off and varied in intensity or frequency of flashing to transmit an alert and message to a user (e.g., indicative of a threat). The light 804 may also function as an anti-theft mechanism. For example, the light 804 may be turned on or flash with a certain intensity and frequency when the light mobility vehicle is moved. It is contemplated that the light 804 positioning may be varied and that the light 804 may be omitted. As shown, the ON/OFF button 806 is positioned on a side of the housing 802 allowing the safety device 800 to be turned on or off, e.g., to conserve power or disconnect the safety device 800 (and user) from other entities. The power input 808 may be positioned on a side of the housing 802. The power input 808 may be configured to power a battery positioned inside the housing 802. The power input 808 may be a USB port. For example, the safety device 800 may be coupled to an external battery via the power input 808. It is contemplated that the USB port may also be used to extract data from the safety device 800 (e.g., for servicing or collecting stored data locally). As shown, the power input 808 has a cover 810 to protect the power input 808 from debris and damage. The safety device 800 may be waterproof. For example, the cover 810 may include a waterproof seal to prevent water from entering the power input 808. The safety device 800 may be a single component, preventing water from leaking through cracks or edges of the safety device 800. In these embodiments, the cover 810 and/or ON/OFF button 806 may be separate components and may include waterproof seals to prevent water from entering the safety device 800.

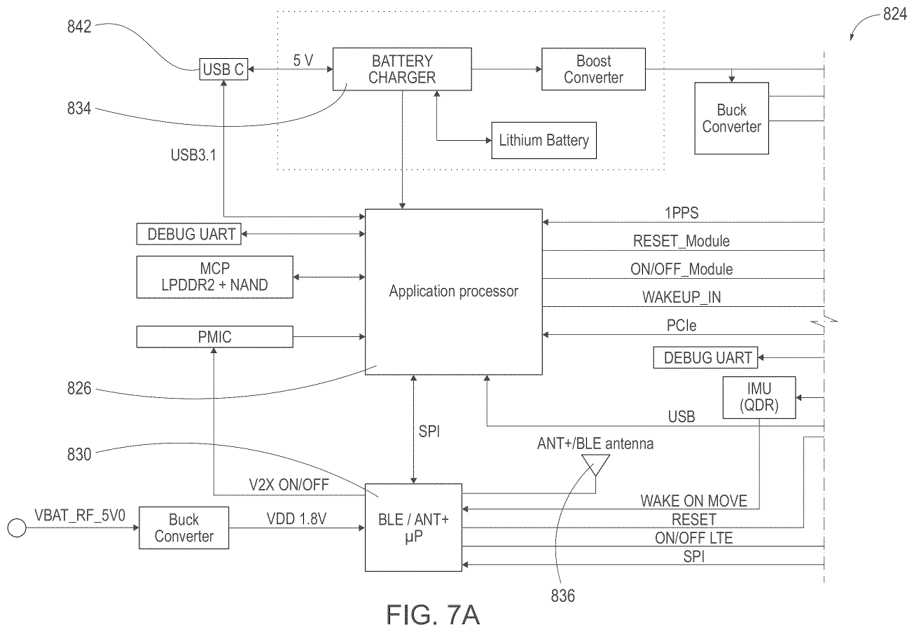

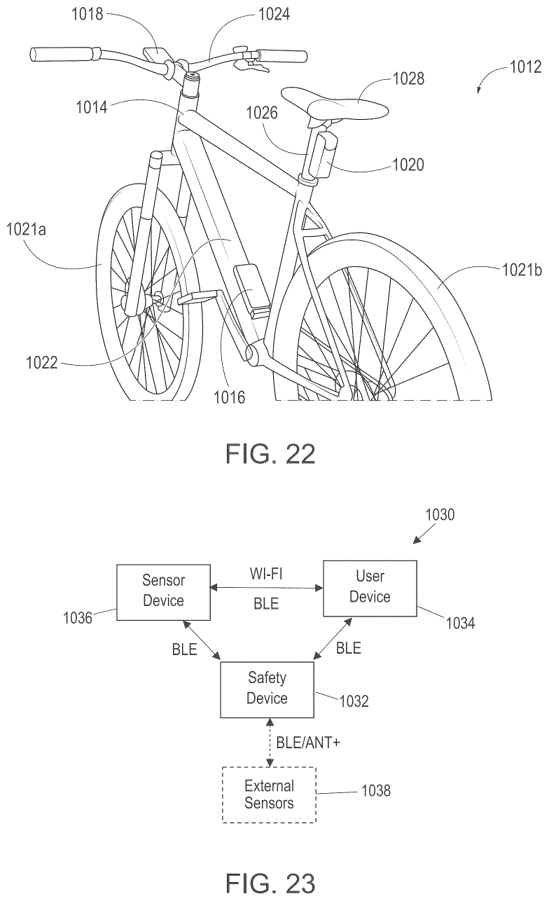

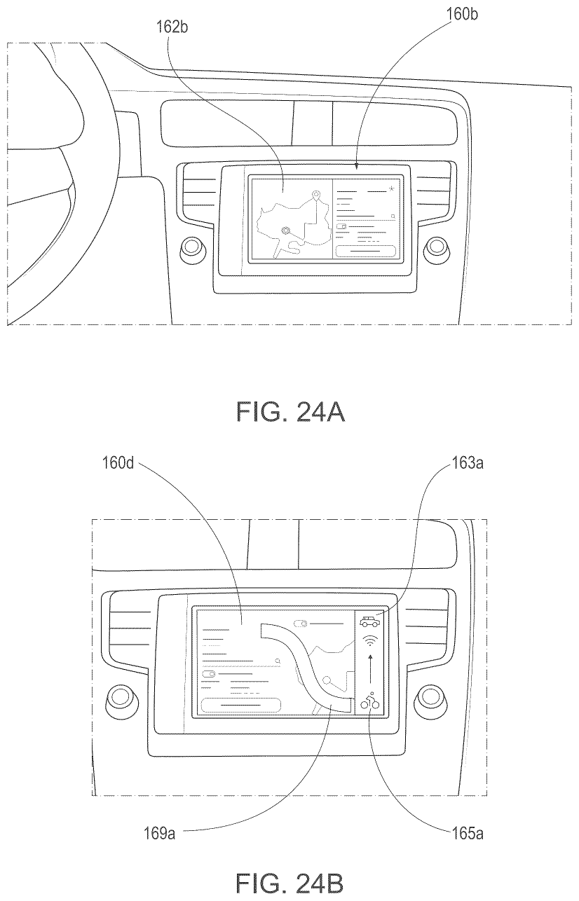

FIG. 5 is a simplified diagram of exemplary safety device hardware architecture 812 of a safety device described herein, e.g., of safety device 103 or safety device 800. As shown, the safety device hardware architecture 812 includes a processor 814, a C-V2X modem 816, a cellular modem 818, and a Bluetooth Low Energy (BLE) modem 820. The processor 814 and modems 816, 818, 820 are positioned within a housing 822. The processor 814 and modems 816, 818, 820 may be conventional devices and may be selected based on the form factor and desired power capabilities of the safety device. An exemplary processor 814 is a Qualcomm® SA2150P application processor. As discussed in more detail below, the processor 814 may execute local or edge processing for the safety device, enabling the safety device to aggregate, store, analyze, and learn from safety-related data received (e.g., received by one or more of the modems 816, 818, 820). An exemplary C-V2X modem 816 may be Quectel C-V2X AG15 or Qualcomm® C-V2X 9150. The C-V2X modem 816 may communicate with other C-V2X modems within a short distance (e.g., to transmit and receive position data approximately 10 times per second). An exemplary cellular modem 818 may be an LTE or 4G modem. As an example, the cellular modem 818 may be Quectel EG95 or BG95. The cellular modem 818 may enable the safety device to transmit and receive information from the one or more servers 108, which may be used by the processor 814. An exemplary BLE modem 820 is a Nordic® nRF52. The BLE modem 820 may enable the safety device to communicate with other local devices (e.g., a local sensor device or user device as described with respect to FIGS. 22 and 23).

While certain embodiments of the safety device are depicted in the figures, various other embodiments of the safety device are contemplated. The safety device may include one or more connectivity devices, processors, sensors, feedback components, input components, and power sources. In some embodiments, the safety device includes a C-V2X module and LTE module. The safety device may include an external antenna. In these embodiments, the safety device may further include one or more of Wi-Fi, BLE, ANT+, and CAN bus. The safety device may include one or more speakers, USB ports, indicators (e.g., battery charge indicator), sensors, and lights (e.g., LEDs). The safety device may include a power source (e.g., battery). The safety device may include a power on button to turn on the power source. In some embodiments, the power source is omitted. The safety device may further include a microphone.

In some embodiments, the LTE module may be omitted from the safety device. For example, the safety device may include a C-V2X module. In these embodiments, the safety device may further include BLE and/or Wi-Fi. The safety device may include one or more speakers, USB ports, indicators (e.g., battery charge indicator), sensors, and lights (e.g., LEDs). The safety device may include a power source (e.g., battery). The safety device may include a power on button to turn on the power source. In some embodiments, the power source is omitted. The safety device may further include a microphone.

In some embodiments, the safety device may include a camera and/or light. For example, the safety device may include a C-V2X module, an LTE module, a camera, and a rear light. The camera (or other sensor therein) may have object detection functionality or such functionality may be omitted. In these embodiments, the safety device may further include one or more of Wi-Fi, BLE, and ANT+. The safety device may include one or more speakers, microphones, USB ports, indicators (e.g., battery charge indicator), sensors, and lights (e.g., LEDs). The safety device may include a power source (e.g., battery). The safety device may include a power on button to turn on the power source. In some embodiments, the power source is omitted. The safety device may be positioned under a seat of the light mobility vehicle (e.g., on the seat post) such that the camera is rear-facing.

In some embodiments, the camera may be omitted from the safety device. In some embodiments, the safety device may include a C-V2X module, an LTE module, and a light. In some embodiments, the safety device may include an LTE module and a light. In some embodiments, the safety device may include a C-V2X module and a light.

In several embodiments, the safety device receives safety-related data directly from one or more entities in a short-distance range (e.g., within several hundred meters, e.g., 300 meters). For example, the safety device may communicate with the one or more entities via C-V2X communication protocol. As an example, the safety device and the one or more entities may share basic safety messages (BSM) via the C-V2X communication protocol. Additionally or separately, the safety device may receive safety-related data indirectly or via a network/cloud/server. For example, the safety device may exchange safety-related data with one or more entities via a cellular network (e.g., LTE). The safety device may switch from a cellular network (e.g., LTE) to C-V2X protocol when entities are within a short-distance range (e.g., within 300 meters) to reduce latency in data exchange (as latency can occur when data is exchanged via the cellular network).

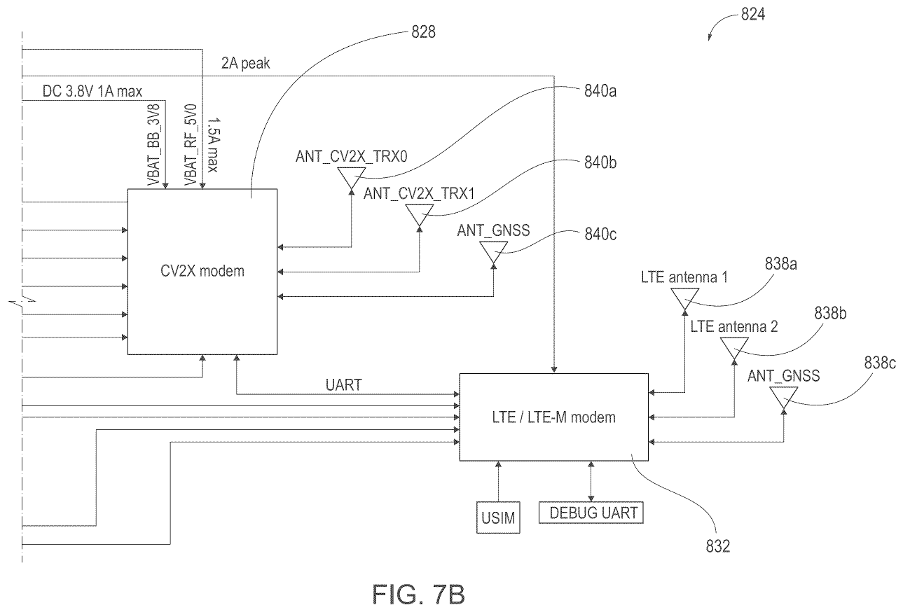

FIG. 6 shows an illustration of an exemplary safety system 100-1 that employs such system architecture. As shown, the system 100-1 includes different communication protocols that operate within different distances relative to a smart bicycle 450 (i.e., a bicycle with a safety device described herein). As shown, data is transmitted and received via C-V2X sensors within a short-distance range 454, and data is transmitted and received via a cellular network (e.g., 4G or 5G) within a long-distance range 456. In the depicted example, a smart bicycle 450 includes a C-V2X chip and a GPS sensor. The GPS sensor calculates the position of the smart bicycle 450 and sends this entity data to the C-V2X chip, which operates within a short-distance range 454 to transmit the entity data collected from the GPS sensor to another vehicle within the short-distance range (e.g., to a compatible vehicle connectivity device of the first vehicle 452a) and to receive entity data from another vehicle (e.g., from a compatible vehicle connectivity device) within the short-distance range 454, such as the first vehicle 452a. When a vehicle is outside the short-distance range 454 and within a long-distance range 456, such as the second vehicle 452b, entity data is no longer received and transmitted via the C-V2X chip, rather, entity data (e.g., as determined by a GPS sensor associated with the second vehicle 452b) is received by the smart bicycle 450 via a cellular network (e.g., 4G, 5G, LTE, etc. network). When the second vehicle 452b comes within the short-distance range 454 relative to the smart bicycle 450, the smart bicycle 450 can detect the relative location of the second vehicle 452b based on the information received via the C-V2X chip. By using the C-V2X chip to detect vehicles within the short-distance range 454, latency in data exchange between the vehicles is reduced such that real-time collisions can be avoided as the vehicles move closer to one another.

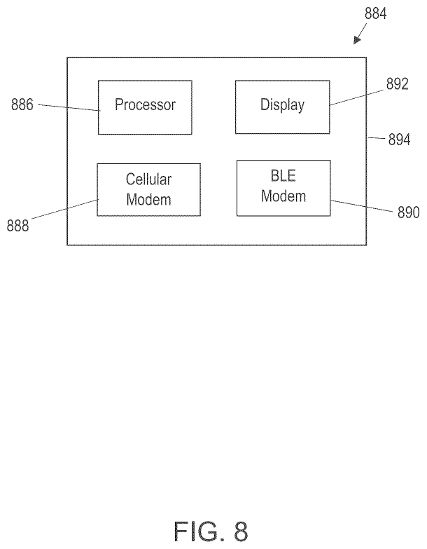

FIGS. 7A-B show a diagram of exemplary safety device hardware architecture 824. FIG. 7B is the right side continuation of the hardware architecture 824 diagram shown in FIG. 7A. As shown, the safety device hardware architecture 824 includes an application processor 826, a C-V2X modem 828, a BLE/ANT+ microprocessor 830, and a cellular modem 832 (e.g., LTE/LTE-M), and a battery 834. The C-V2X modem 828, BLE/ANT+ microprocessor 830, and cellular modem 832 are coupled to one or more antennas. The antennas may be located in an area of the safety device that is selected to reduce interference and conform to the form factor of the safety device. As shown, the BLE/ANT+ microprocessor 830 is coupled to a BLE/ANT+ antenna 836, the cellular modem 832 is coupled to three cellular (LTE) antennas 838a,b,c, and the C-V2X modem 828 is coupled to three C-V2X antennas 840a,b,c. One or more antennas may be positioned within the housing 852. In the depicted embodiment, the architecture 824 includes a USB port 842 for charging the battery 834. It is contemplated that the safety device hardware architecture 824 may include one or more sensors 122 (e.g., a GPS, camera, light, microphone, IMU, etc.).

### Dedicated User Devices

As discussed with respect to the system 100 of FIG. 1, the one or more user devices 106 may include a dedicated user device. A dedicated user device may include one or more processing elements, one or more connectivity modules, one or more input components, one or more output components, one or more sensors, and one or more feedback components. The one or more connectivity modules may include one or more of a Wi-Fi modem, a Bluetooth modem (BLE), a cellular modem (e.g., 3G, 4G, 5G, LTE, or the like), an ANT+ chipset, and the like. The one or more input components, one or more output components, and/or one or more feedback components may include one or more of a display, a microphone, a speaker, a light, a haptic response, and the like. The display may include local resistive buttons. In some embodiments, the dedicated user device includes a sensor, such as a camera, accelerometer, light sensor, thermometer, etc. The dedicated user device may receive safety-related data, e.g., from a safety device, and display safety-related data on a display graphical user interface.

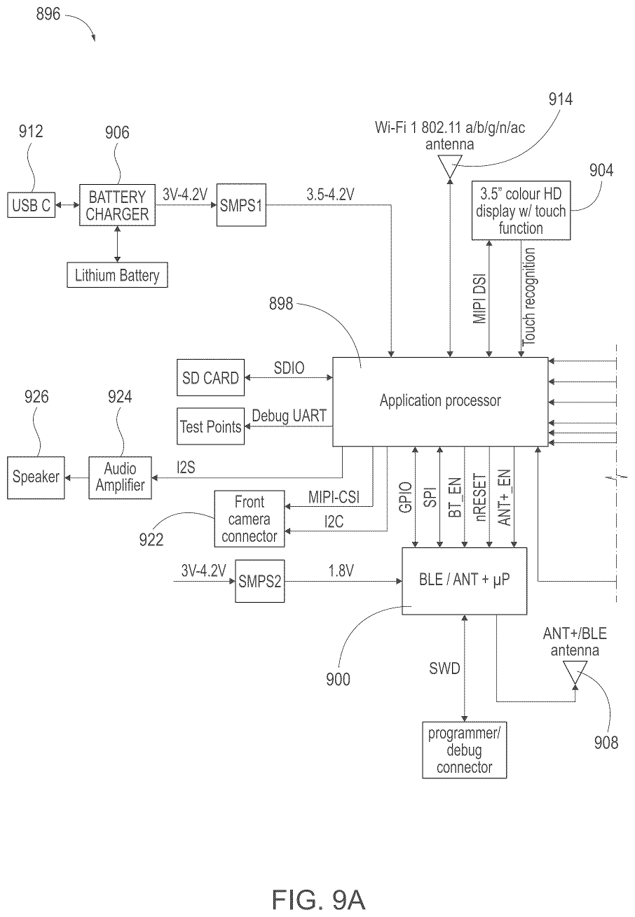

FIG. 8 is a simplified diagram of exemplary dedicated user device hardware architecture 884 of a dedicated user device described herein. As shown, the user device hardware architecture 884 includes a processor 886, a cellular modem 888, a Bluetooth Low Energy (BLE) modem 890, and a display 892. The processor 886 and modems 888, 890 are positioned within a housing 894 that includes the display 892. The processor 886 and modems 888, 890 may be conventional devices and may be selected based on the form factor and desired power capabilities of the user device. An exemplary processor 886 is a Qualcomm® QCS6125 application processor.

The processor 886 may execute local or edge processing for the user device, enabling the user device to aggregate, store, analyze, and learn from safety-related data received (e.g., received by one or more of the modems 888, 890). It is contemplated that the processor 886 may execute the same or similar functions as safety devices described herein (e.g., execute the safety methods described herein). For example, the processor 886 may determine (based on sensor data and other data received) entities within proximity, collision probabilities, threats (e.g., actual and anticipated), road/surface hazards, user actions (e.g., to avoid safety risks), and the like, and transmit notifications and alerts related to the same.

The cellular modem 888 may be an LTE or 5G modem. An exemplary cellular modem 888 is Quectel RG500Q. The cellular modem 888 may enable the user device to transmit and receive information from the one or more servers 108, which may be displayed via the display 892. The cellular modem 888 may enable the user device to communicate with other devices having cellular modems over the network (e.g., vehicles that are not equipped with C-V2X modems). An exemplary BLE modem 890 is a Nordic® nRF52. The BLE modem 890 may enable the user device to communicate with other local devices (e.g., a local sensor device or safety device as described with respect to FIGS. 22 and 23). For example, the BLE modem 890 may enable the user device to communicate with a local or associated safety device, which in turn may communicate with vehicles equipped with C-V2X modems. As such, the user device may be configured to communicate with other vehicle devices that are equipped with different type modems (e.g., a cellular modem or C-V2X modem). The display 892 may provide an HMI to relay information to a user (e.g., based on logic executed by the one or more connected devices).

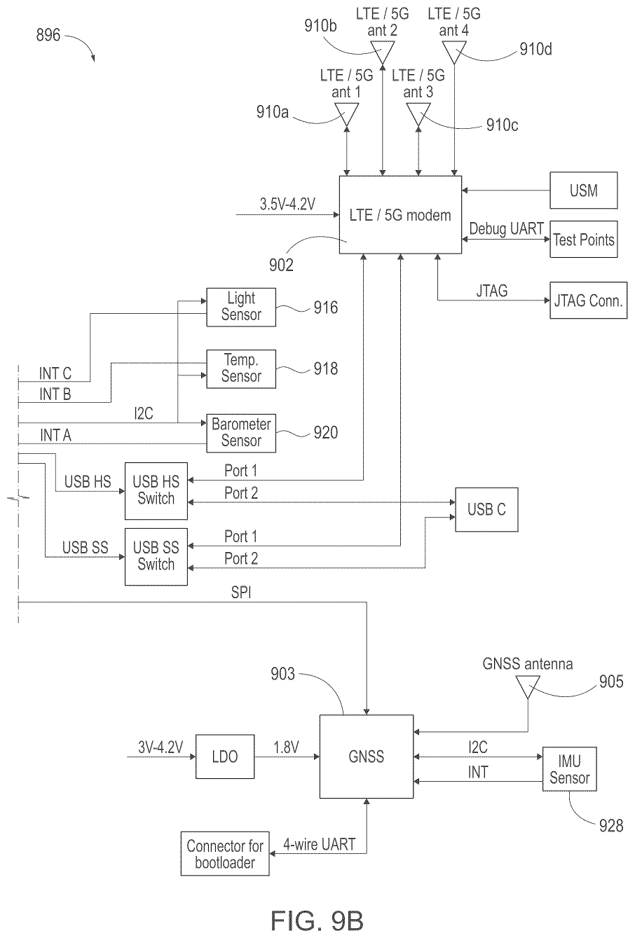

FIGS. 9A-B show a diagram of exemplary dedicated user device hardware architecture 896. FIG. 9B is the right side continuation of the hardware architecture 896 diagram shown in FIG. 9A. As shown, the user device hardware architecture 896 includes an application processor 898, a BLE/ANT+ microprocessor 900, a cellular modem 902 (e.g., LTE/5G), a GNSS receiver 903 (or GPS receiver), a display 904, and a battery 906. As shown, the display 904 may be a 3.5″ color HD touch display. The application processor 898, BLE/ANT+ microprocessor 900, cellular modem 902, and GNSS receiver 903 are coupled to one or more antennas. As shown, the application processor 898 is coupled to a Wi-Fi antenna 914, the BLE/ANT+ microprocessor 900 is coupled to a BLE/ANT+ antenna 908, the cellular modem 902 is coupled to four cellular (LTE/5G) antennas 910a,b,c,d, and the GNSS receiver 903 is coupled to a GNSS antenna 905. In the depicted embodiment, the architecture 896 includes a USB port 912 for charging the battery 906.

The application processor 898 is coupled to one or more sensors. As shown, the application processor 898 is coupled to a light sensor 916, a temperature sensor 918, and a barometer sensor 920. The application processor 898 may be coupled to a front camera of the user device or a front camera connector 922, as shown, that is configured to couple with a camera. The application processor 898 is further coupled to an audio amplifier 924, which is coupled to a speaker 926. The speaker 926 may provide audio feedback from the user device. In some embodiments, a microphone may be included to provide audio input of environmental sounds that may be analyzed and interpreted by the application processor 898 (e.g., to determine type of sound such as children playing, gun shots, braking, etc., and whether the sound is a threat).

The GNSS receiver 903 is coupled to an inertial measurement unit (IMU) sensor 928, which may be configured to measure angular rate, force, magnetic field, and/or orientation. It is contemplated that a GPS receiver or other positioning or navigational device may be included to determine positioning, navigation, timing, and location. The 5G/LTE connectivity may enable online navigation. The data received from the light sensor 916, temperature sensor 918, barometer sensor 920, camera (if included), GNSS receiver 903, and IMU sensor 928 may be safety-related data that is received and analyzed by the application processor 898.

### Sensor Devices

A sensor device may include one or more sensors. In some embodiments, a sensor device may further include one or more connectivity modules. As an example, a sensor device may include a camera and LTE. The sensor device may include one or more feedback components. For example, the sensor device may include a light. In some embodiments, a sensor device may include one or more processors. The sensor device may transmit sensor data to a safety device and/or dedicated user device. As an example, the sensor device may include a camera that transmits image data (e.g., streaming video) to a dedicated user device.

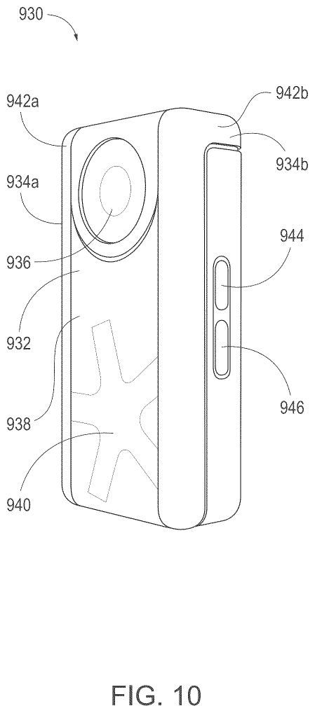

FIGS. 10-13 show exemplary sensor devices and sensor device hardware architecture. FIG. 10 is an image of an exemplary sensor device 930. The sensor device 930 includes a rear surface 932, side surfaces 934a,b, and a front surface (surface opposing the rear surface 932). The rear surface 932 may include a camera 936, a reflector 938, and a rear light 940. The side surfaces 934a,b may include side lights (e.g., side light 942b) and side cameras and/or reflectors (not shown). As shown, the side surface 934b also includes an ON/OFF button 944 for powering the sensor device 930 on or off and a power port 946 (e.g., USB port) having a port cover 948. The front surface (not shown) may include a mount interface, e.g., to mount the sensor device 930 to a light mobility vehicle. For example, the mounting interface may be a recess, slot, clip, or the like. The sensor device 930 depicted has a rectangular form factor, but other shapes are contemplated based on the desired positioning of the sensor device 930 on a light mobility vehicle. It is contemplated that one or more of the camera 936, reflector 938, and light 940 may be omitted from or duplicated on the sensor device 930.

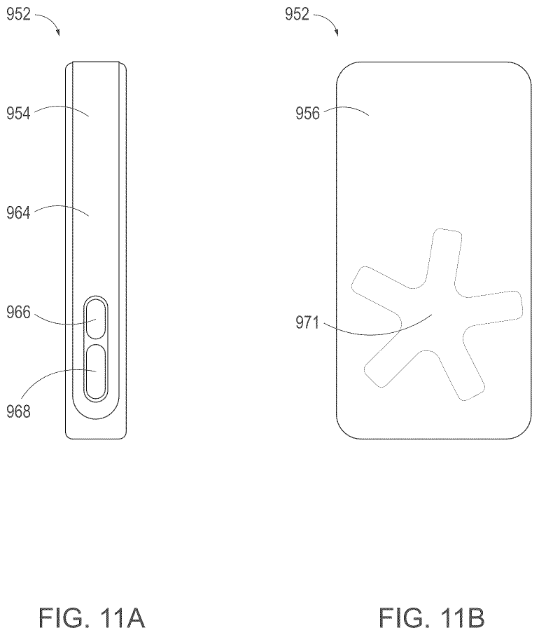

FIGS. 11A-B show images of another exemplary sensor device 952 that omits a camera. FIG. 11A is a rear elevation view of the sensor device 952 and FIG. 11B is a side (right or left) elevation view of the sensor device 952. As shown, the sensor device 952 has a rear surface 954, a side surface 956 (the other side surface not shown is a mirror image), a front surface opposite the rear surface 954, a bottom surface, and a top surface. The rear surface 954 may include a reflective surface 964, an ON/OFF button 966, and a power port 968 (e.g., USB port). It is contemplated that the reflective surface 964 may include a light (e.g., LED lights). The side surface 956 may include a reflector 971 and/or light. The other side surface (not shown) may also include a reflector and/or light. The front surface (e.g., surface opposing the rear surface 954) may include a mount interface, e.g., to mount the sensor device 952 to a light mobility vehicle. For example, the mount interface may be a slot or recess on the front surface.

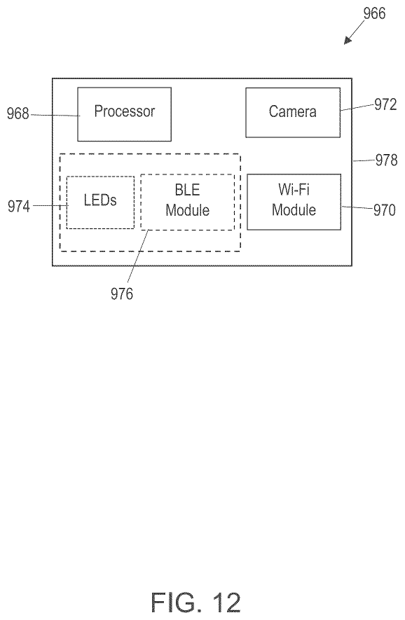

FIG. 12 is a simplified diagram of exemplary sensor device hardware architecture 966 of a sensor device described herein, e.g., of sensor device 930 or sensor device 952. As shown, the sensor device hardware architecture 966 includes a processor 968, a Wi-Fi module 970, and a camera 972. The sensor device hardware architecture 966 may include LEDs 974 and a BLE module 976 (and include or omit the camera 972). As shown, the processor 968 and Wi-Fi module 970 are positioned within a housing 978 that includes the camera 972. The processor 968 and modules 970, 976 may be conventional devices and may be selected based on the form factor and desired power capabilities of the sensor device. The processor 968 may execute local or edge processing for the sensor device, enabling the sensor device to aggregate, store, analyze, and learn from safety-related data received (e.g., sensor data received by the camera 972). For example, the processor 968 may be configured to execute an image processing algorithm to analyze and categorize object data (e.g., to determine hazards or threats). An exemplary processor 968 may be a DNN application processor, which includes object detection and classification capabilities.

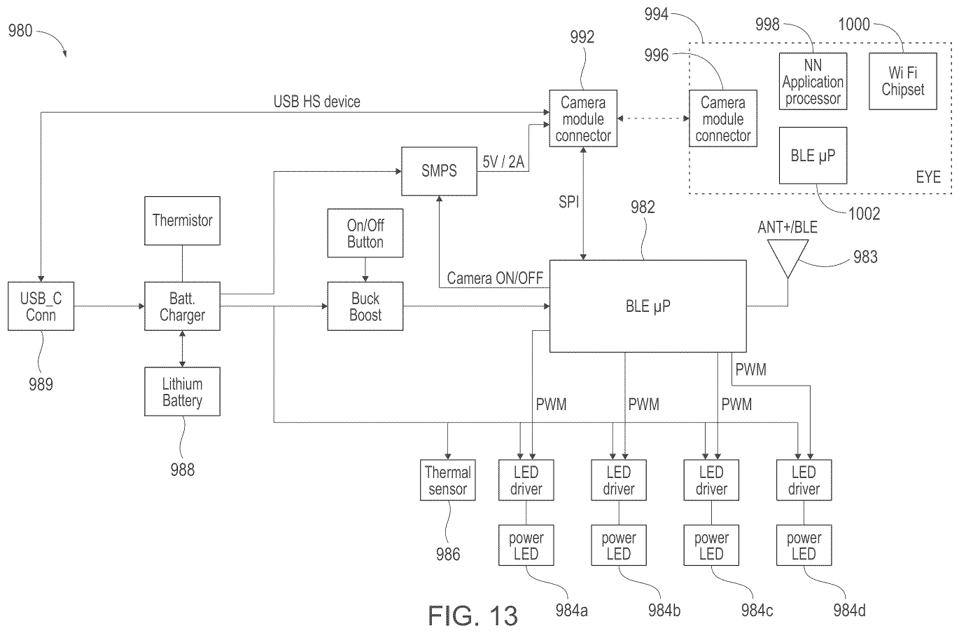

FIG. 13 is a diagram of exemplary sensor device hardware architecture 980. As shown, the sensor device hardware architecture 980 includes a BLE microprocessor 982, a plurality of LEDs 984a,b,c,d, a thermal sensor 986, and a battery 988. The BLE microprocessor 982 may be coupled to an ANT+/BLE antenna 983. In the depicted embodiment, the sensor device hardware architecture 980 includes a USB port 989 for charging the battery 988. The sensor device hardware architecture 980 may include a camera module connector 992. The camera module connector 992 may couple with a camera module 994 via a second camera module connector 996. The camera module 994 may include an application processor 998, a Wi-Fi chipset 1000, and a camera BLE microprocessor 1002.

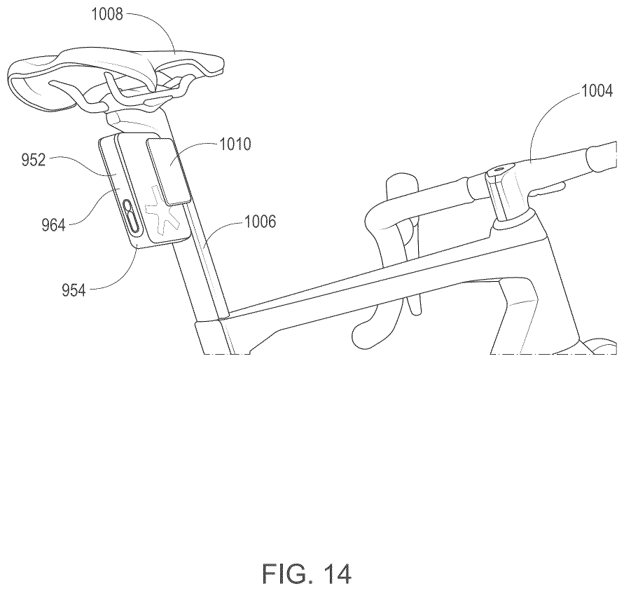

In several embodiments, the sensor device is positioned on a rear side of a light mobility vehicle (e.g., such that the camera is rear-facing), for example, on the rear of a bicycle seat post. FIG. 14 shows an image of an exemplary positioning of the sensor device 952 on a bicycle 1004. As shown, the sensor device 952 is positioned on a seat post 1006 of the bicycle 1004 underneath the seat 1008. The mount interface of the sensor device 952 is coupled to a mount 1010 on the seat post 1006 such that the rear surface 954 and reflective surface 964 are rear-facing away from the bicycle 1004 to alert oncoming entities of the cyclist. In embodiments where the rear surface 954 includes a light, the light may be varied (e.g., by intensity or frequency of flashing) to alert an oncoming entity. For example, the light may flash more frequently or brighter as an entity gets closer to the bicycle 1004. As another example, the light may flash on the left side to indicate the bicycle 1004 is turning left or flash on the right to indicate a right turn (e.g., based on user input or a pre-determined route). The lights may also flash as an anti-theft mechanism. It is contemplated that the sensor device 930 may be mounted on the bicycle 1004 in a similar manner with the camera 936 rear-facing away from the bicycle 1004. In these embodiments, the camera 936 may capture image data behind the bicycle 1004 and transmit feedback (e.g., streaming video) or an alert to a user device.

Safety Device Integration with Light Mobility Vehicle

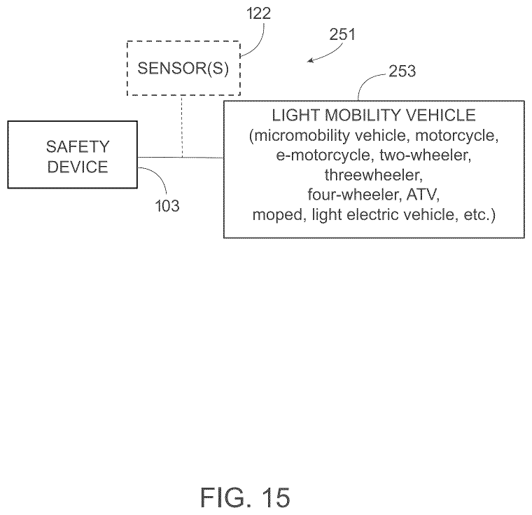

In several embodiments, a disclosed safety device is coupled to a light mobility vehicle. For example, FIG. 15 is a simplified block diagram of a safety light mobility vehicle 251 having a safety device 103 coupled to a light mobility vehicle 253. As shown, the one or more sensors 122 may be coupled to or in communication with the light mobility vehicle 253 and in communication with the safety device 103 coupled to the light mobility vehicle 253. The one or more sensors 122 may be coupled to one or more parts or systems of the light mobility vehicle 253, such as, for example, a wheel, frame, handlebar/hand grip, seat, camera, light, drive system, gear shift system, brake system, or the like. As discussed above, it is contemplated that the one or more sensors 122 may be part of the safety device 103 or part of a disclosed sensor device in communication with the safety device 103.

A light mobility vehicle may include a micromobility vehicle (e.g., an electronic or non-electronic bicycle, a pedal assisted bicycle, an electric or non-electric scooter, an electric or non-electric skateboard, an electric or non-electric unicycle, an electric or non-electric tricycle, an electric or non-electric quadricycle, etc.), a motorcycle, an e-motorcycle, a two wheeler, a three wheeler, a four wheeler, an ATV, a moped, a light electric vehicle (EV), a micro-EV, and the like. The safety device and components thereof may be coupled to one or more light mobility vehicle components or parts, including, for example, the handlebars, head unit (e.g., of a motorcycle), bicycle or other light mobility vehicle computer, display, frame (e.g., down tube, top tube, seat tube, etc.), battery (e.g., electric bicycle battery, electric vehicle battery, etc.), motor, transmission, controller or remote (e.g., motor controller, switch controller/remote, etc.), throttle, gear shift, derailleur, and the like. The safety device and components thereof may be coupled to one or more light mobility vehicle components or parts physically, by electronic means (e.g., digital or wired connection), wirelessly, or the like. As an example, the safety device may wirelessly communicate with a light mobility device computer or display (e.g., an e-bike computer or display).

The safety device or its components (e.g., the one or more sensors) may be coupled to the light mobility vehicle in a manner that reduces signal interference. For example, the safety device (or its components) may be coupled to the light mobility vehicle in a manner that minimizes road interference (e.g., at a position further from the road), user interference (e.g., at a position further from the user or where the user is unlikely to obstruct the safety device from above for extended time periods), view interference (e.g., at a position where other components and/or the user do not obstruct the safety device's view up to the sky, which is important for satellite or cellular communications, or view to either side, front, and back when communicating with another vehicle), and/or other interference (e.g., at a position where the motor, vehicle battery, other vehicle sensors, etc. do not obstruct the functionality and/or communication of the safety device).

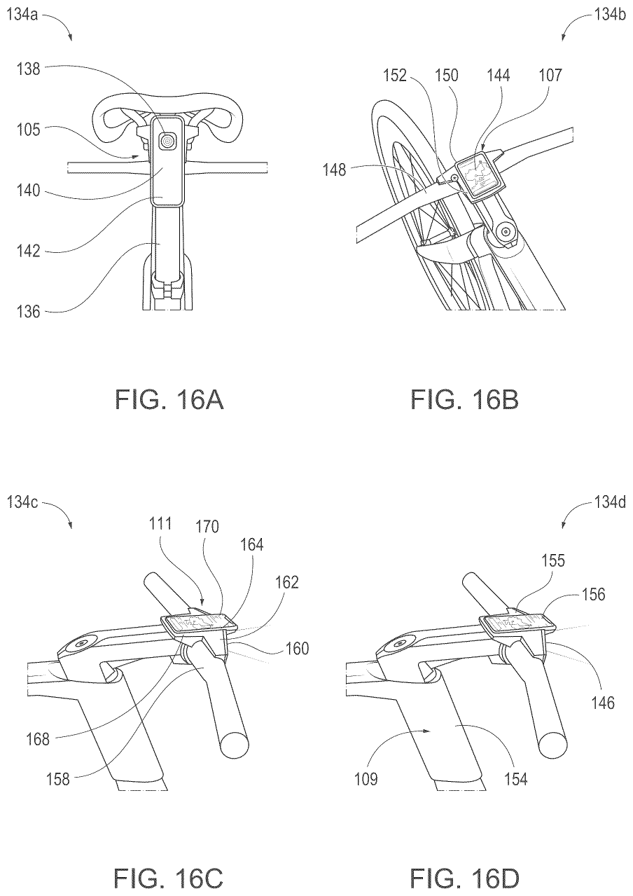

FIGS. 16A-F show exemplary safety device positioning relative to micromobility vehicles and their components. Specifically, the micromobility vehicles depicted in FIGS. 16A-F are safety bicycles 134a-f that incorporate a safety device 105, 107, 108, 111, 1180, 103-1 to 103-13. FIG. 16A shows a safety bicycle 134a having a safety device 105 coupled to the rear of the safety bicycle 134a, specifically to an outer surface of the seat post 136. In the depicted example, the safety device 105 includes a waterproof housing 142 with a camera 138 coupled to an outer surface 140 for detecting motion and objects behind the safety bicycle 134a.

In the example depicted in FIG. 16B, the safety bicycle 134b includes a safety device 107 coupled to a top surface of handlebars 148. In this example, the safety device 107 includes a display 144 (e.g., a feedback component 123) on the outer surface 150 of its housing 152; however, it is contemplated that a smart display may be a separate component (e.g., a user device 106 positioned on the handlebars) in communication with a safety device that is positioned elsewhere on the micromobility vehicle. It is contemplated that the safety device 107 may be a fixed feature or removable from the safety bicycle 134b.

In the example depicted in FIG. 16C, the safety bicycle 134c includes a safety device 111 coupled to a top surface of handlebars 158. In this example, the safety device 111 includes a light 160 (e.g., a feedback component 123) on a front surface of the housing 162. It is contemplated that the light may include a light sensor as discussed above. In the depicted example, the housing 160 includes a recession 164 on a top surface 168 configured to receive a smartphone 170 (e.g., a type of user device 106).

In the example shown in FIG. 16D, the safety bicycle 134d includes a safety device 109 that is contained within a head tube 154. In this example, the safety device 109 is in communication with a light 146 that is a separate component from the safety device 109. The light may include a light sensor as discussed above that is in communication with the safety device 109 processing element. In the example shown, the safety bicycle 134d includes a holder 155 for a smartphone 156 that is in communication with the safety device 109. While FIGS. 16C and 16D show a smartphone 170, 156, respectively, it is contemplated that the smartphones 170, 156 may be replaced by dedicated user devices described herein.

In the example shown in FIG. 16E, the safety bicycle 134f includes a safety device 1180 coupled to or integrated with a stem 1190 of a bicycle or ebike. As shown, the stem 1190 includes a stem housing 1192 and a handlebar clamp 1194. The handlebar clamp 1194 is configured to receive handlebars. The stem housing 1192 may form a stem cavity. A safety device described herein may be positioned inside the stem cavity. For example, a circuit board having one or more disclosed connectivity devices and one or more processors may be positioned inside the stem cavity. The circuit board may further include one or more sensors described herein. As shown, the stem housing 1192 includes a display 1196 on a top surface 1198 of the stem housing 1192. The display 1196 may be in communication with the one or more processors and may receive input based on data received by the one or more connectivity devices and/or one or more sensors. It is contemplated that the display 1196 may be omitted. For example, the safety device may be in communication with one or more feedback components or an external display or user device. In the depicted embodiment, the stem 1190 is coupled to a bicycle head tube 1200. It is contemplated that the stem 1190 including a disclosed safety device may be provided as a separate component of the bicycle or ebike. While the safety device 134f depicted in FIG. 16E is integrated with the stem 1190, it is contemplated that a safety device may be positioned on a top surface of a bicycle stem.

FIG. 16F shows exemplary locations for a safety device 103 on a micromobility vehicle 132-1, in this example, a safety bicycle 134e. As shown, a safety device 103-1 to 103-7 may be positioned on a frame 180 of the safety bicycle 134e, such as, for example, safety device 103-1 positioned on a rear surface of the seat tube 182, safety device 103-2 positioned on a front surface of the seat tube 182 and partially on a lower surface of the top tube 184, safety device 103-3 positioned on a lower surface of the top tube 184 and partially on a front surface of the seat tube 182, safety device 103-4 positioned on a lower surface of the top tube 184 and partially on the head tube 186, safety device 103-5 positioned on the down tube 188 proximate the head tube 186, safety device 103-6 positioned on the down tube 188 proximate the chain ring 190, safety device 103-7 positioned on a front surface of the seat tube 182 proximate the chain ring 190, safety device 103-9 positioned under the seat 194, safety device 103-10 positioned on a rear surface of the seat post 196, safety device 103-11 positioned on a front surface of the seat post 196, safety device 103-12 positioned on a top surface of the top tube 184 near the seat post 196, or safety device 103-13 positioned on a top surface of the top tube 184 near the handlebars 198. As another example, a safety device 103-8 may be coupled to a gear system 192 of the safety bicycle 134e. The positions shown in FIG. 16F are meant as illustrative examples and other positioning of a safety device 103 relative to a micromobility vehicle 132 is contemplated.

In several embodiments, a safety device, or components thereof, is coupled to a battery or other power source of a light mobility vehicle (e.g., the battery that powers the motor of an electric bicycle or ebike). A vehicle battery may include a battery housing, one or more battery cells, and a Battery Management System (BMS), or BMS circuit. The battery housing may be made of a durable plastic, composite material, or metal. The battery cells may include lithium-ions or nickel metal hydride (NiMH) or other chemistry and may have a cylindrical, prismatic, or pouch shape. The BMS circuit may sense the voltage on each cell and activate cutoffs to prevent the cells from being overcharged or over discharged. The battery cells and BMS circuit may be positioned inside the battery housing. In some embodiments, the BMS circuit may be omitted, as described in further detail below. The battery may be a 36V-52V battery or other battery suitable for a light mobility vehicle. The battery may be positioned on the light mobility vehicle frame, e.g., on the top tube or down tube or other frame component, partially or entirely inside the light mobility vehicle frame (e.g., out of view), in a basket coupled to the front of the light mobility vehicle, or on a rack coupled to the light mobility vehicle, such as a rack positioned over a wheel of a bicycle. The battery may be removable from or fixed to the light mobility vehicle. Other power sources are contemplated, including for example, a solar panel or a fuel tank. For example, the safety device may be coupled to a fuel tank (e.g., a top surface of the fuel tank) of a light mobility vehicle (e.g., a motorcycle).

In some embodiments, the safety device is coupled to an external surface of the power source. For example, the safety device may be coupled to a top surface of the battery housing. By coupling the safety device to the top surface, interference from the road or ground may be mitigated. The safety device may be configured to couple to the battery as a power source for the safety device. For example, the safety device may couple to the battery cells for power. The safety device may further include a separate power source or the separate power source may be omitted.

In some embodiments, the safety device is removable from the battery housing. For example, the safety device may be coupled to the battery housing by a clip, track (e.g., for sliding the safety device on or off), magnets, snaps, or other temporary coupling means that are coupled to one or both of the safety device and battery housing. The safety device can either be removably coupled to the outside (e.g., outer surface) of the battery housing or temporarily positioned in a designated portion within the battery housing. As an example, the safety device may be coupled to the battery housing when the light mobility vehicle is in use and removed from the battery housing when the user is moving on foot and/or no longer riding on the light mobility vehicle (e.g., placed in a child's backpack). In this example, the safety device may have a separate power source to allow for portable use.

In some embodiments, the safety device is positioned inside the power source or battery housing. The safety device positioned inside the battery housing may include or exclude the safety device housing. For example, where the safety device housing is excluded, a PCB including the one or more connectivity modules, and, in some embodiments, the one or more sensors, may be positioned inside the battery housing. In some embodiments, the safety device may include the BMS circuit. For example, the BMS circuit may be coupled to the PCB of the safety device. In this manner, the electronics included inside the battery housing may be reduced. In other embodiments, the BMS circuit may be separate from the safety device. The safety device may be positioned anywhere inside the battery housing. In some embodiments, the safety device, or components thereof, is positioned inside the battery housing adjacent to the top/upper surface of the battery housing and/or positioned as far away from the road as possible, e.g., to reduce interference from the road and/or reduce interference from objects blocking the safety device's (specifically antenna(s)) view of the sky. The safety device may include a specialized antenna configured to mitigate interference of the battery components with the safety device (e.g., with the one or more connectivity modules). The specialized antenna may be coupled to the PCB. The specialized antenna may be coupled to the one or more connectivity modules and/or to the one or more sensors.

In embodiments where the safety device is positioned inside the battery housing, one or more antennas may be positioned outside the battery housing, e.g., for improved signal strength and reduced interference. As an example, a Laser Direct Structuring (LDS) antenna may be integrated into an external surface of the battery housing, e.g., on a top or upper surface of the battery housing. The one or more antennas may be coupled directly to the safety device or connected via an electrical connection, such as a bare metal spring. Alternatively or additionally, the one or more sensors may be separate from the safety device and positioned outside the battery housing, e.g., on an outer surface, which may be a top surface, of the battery housing. As an example, a GNSS sensor (e.g., GPS sensor) may be coupled to an external surface of the battery housing and in communication with the safety device. For example, the LDS antenna may be a GNSS antenna.

The one or more safety device sensors and/or one or more antennas may be coupled to a component of the light mobility vehicle that is different from where the safety device (specifically, the other components of the safety device) is positioned. For example, the one or more safety device sensors and/or one or more antennas may be coupled to the handlebars, frame, wheel, motor, gears, controller (e.g., switch controller, motor controller, etc.), display, light, camera, and the like. In some embodiments, the one or more safety device sensors and/or one or more antennas may be coupled to a display or a dedicated user device that is coupled to the handlebars (e.g., to the stem of the handlebars). As an example, an LDS antenna, which is in communication with the safety device, may be integrated into an external surface of the light mobility vehicle component or part.

In one embodiment, one or more GNSS sensors (e.g., GPS sensors) are coupled to the handlebars and/or to a display or dedicated user device coupled to the handlebars and/or to a switch remote/controller coupled to the handlebars and in communication with the safety device. Positioning the one or more GNSS sensors on or near the handlebars may be beneficial for reducing interference (e.g., from the ground, another component of the light mobility vehicle, and the user), as the sensor(s) are further away from the ground and are mostly unobstructed from above. Other positionings of the one or more GNSS sensors are contemplated, depending on the shape and structure of the light mobility vehicle, to achieve this same function (e.g., on a frame/housing component above a wheel of a bicycle or scooter). It is contemplated that one or more GNSS sensors may be positioned on or near the handlebars and one or more other GNSS sensors positioned elsewhere on the light mobility vehicle. While a single GNSS sensor is contemplated, including multiple GNSS sensors may increase precision of positioning capabilities of the safety device, including for example “true headings” functionality.

The one or more safety device sensors and/or the one or more antennas, or the display or dedicated user device they are coupled to, may be coupled to the light mobility vehicle's power source (e.g., battery) by a power supply line (e.g., a +36V/GND power cable or DC power line) for power input. The one or more safety device sensors and/or one or more antennas may transmit or inject a signal/data across the power supply line (e.g., battery power line) to the safety device (e.g., to the connectivity module) or vice versa (e.g., by power-line communication or PLC). For example, a GNSS sensor positioned on the handlebars may pass a GNSS signal to the safety device via the power supply line. It is contemplated that other connectors (e.g., cables or wires) (e.g., dedicated connectors) may couple the one or more sensors and/or one or more antennas to the safety device to transmit signals therebetween; however, using the power supply line reduces the complexity and additional expense of added connectors. In some embodiments, the one or more sensors and/or one or more antennas are wirelessly connected to the safety device, are connected to the safety device through the electrical circuitry of the light mobility vehicle, are connected to the safety device through the power cable or power supply line of the light mobility vehicle, and/or are connected to the safety device via direct data cables.

It is contemplated that the safety device may be provided as a separate component that can be integrated into a light mobility vehicle power source or it may be provided as an integral component of a light mobility vehicle power source. In some embodiments, the safety device may be provided as a PCB that includes one or more of the one or more connectivity modules, one or more sensors, and the BMS circuit. In this example, the PCB may be further coupled to the power source. For example, the PCB may be positioned in the battery housing and the BMS circuit may be coupled to the battery cells. In some embodiments, a power source may be provided that includes the safety device. For example, a power source may include the safety device positioned inside the housing.

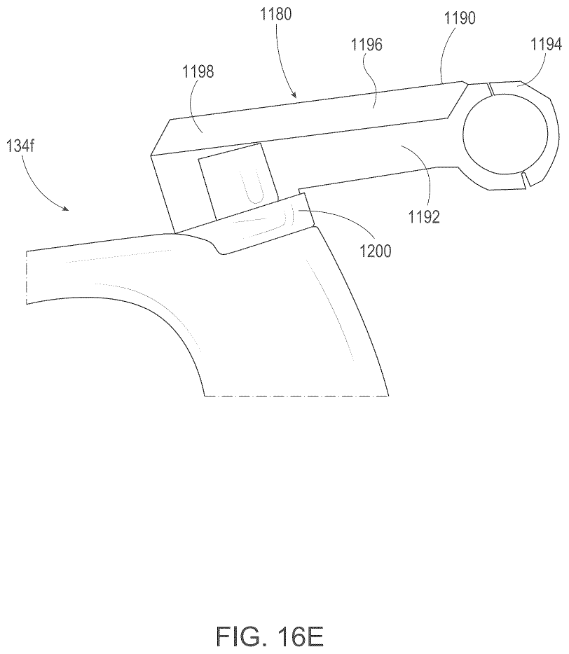

FIGS. 17-21B show an exemplary connected power source, specifically a battery 1100, for a light mobility vehicle 1102 that includes integrated safety device components 1114. FIG. 17 is a side view of a light mobility vehicle 1102 that incorporates a connected power source. As shown, a connected battery 1100 is positioned on or coupled to a down tube 1104 of the light mobility vehicle 1102; however, other positioning of the battery 1100 is contemplated, including, for example, coupled to a top tube 1106, behind or on a seat post 1108 and under a seat 1110, on a rack positioned above a rear wheel 1112, or in a basket or on a rack above a front wheel. Other positioning of the battery 1100 is contemplated for different light mobility vehicles (e.g., scooters, skateboards, etc.).

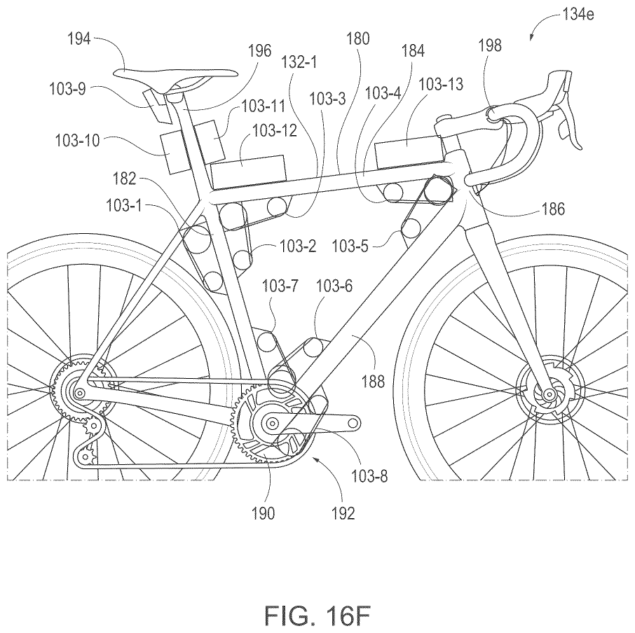

FIG. 18 is an isometric view of the battery 1100 and an exploded isometric view of the battery 1100. As shown, the battery 1100 includes a battery housing 1116, battery cells 1118, and a safety device 1120. The battery housing 1116 includes a top surface 1122 and a bottom surface 1124, which define a battery housing cavity 1123. The safety device 1120 includes a printed circuit board 1126, safety device components 1114, and a BMS circuit 1128. The safety device components 1114 include a connectivity module 1130 and an antenna 1132. In the depicted embodiment, the connectivity module 1130 is coupled to the printed circuit board 1126 and the antenna 1132 is coupled to the top surface 1122 of the battery housing 1116. The BMS circuit 1128 is coupled to the printed circuit board 1126 and to the battery cells 1118. The printed circuit board 1126, including the connectivity module 1130 and BMS circuit 1128, and the battery cells 1118 are positioned inside the battery housing cavity 1123. The battery 1100 can include a shield (not shown) positioned around or on one side of the safety device 1120 and safety device components 1114 to prevent or minimize interference between the safety device 1120 and the other battery components such as the battery cells 1118 and/or between safety device components 1114 and the BMS circuit 1128.

The antenna 1132 may be an LDS antenna printed or otherwise integrated into the top surface 1122 of the battery housing 1116. It is contemplated that the antenna 1132 may be a separate component coupled to the top surface 1122. The antenna 1132 may be positioned above the connectivity module 1130 and may be coupled to the connectivity module 1130 to pass signals therebetween. As an example, the antenna 1132 may be a GNSS (e.g., GPS) antenna that passes GNSS signals to the connectivity module 1130. While the antenna 1132 is depicted on the top surface 1122, it is contemplated that the antenna 1132 may be positioned on another surface of the battery housing 1116 or inside the battery housing cavity 1123, e.g., on the printed circuit board 1126 coupled to the connectivity module 1130. However, the positioning of the antenna 1132 on the top surface 1122 may optimize signal strength and reduce interference.

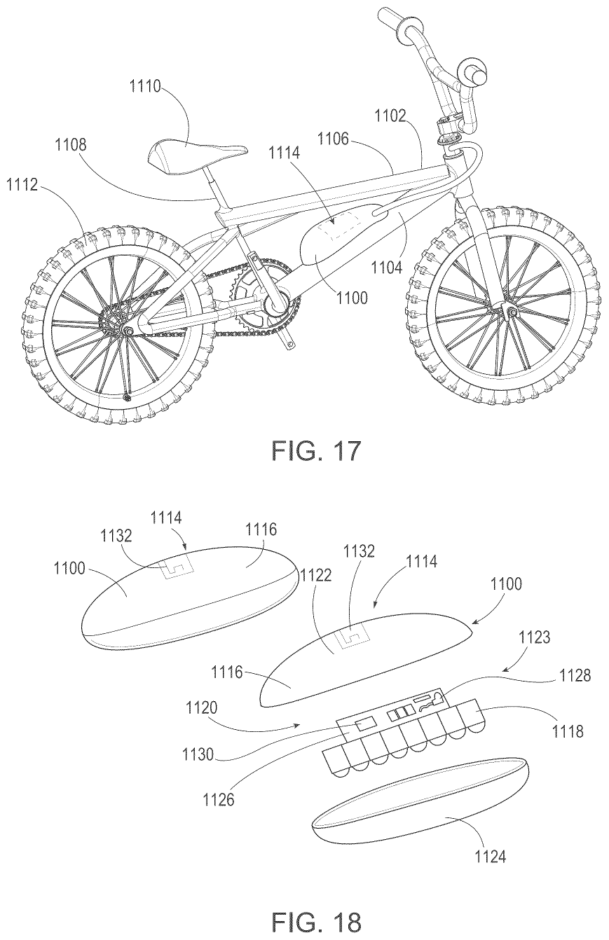

FIG. 19 is a side view of a light mobility vehicle 1140 with an integrated safety system. In the depicted embodiment, a safety device 1142 is coupled to a battery 1144, and a sensor 1146 is coupled to handlebars 1148 of the light mobility vehicle 1140, for example, integrated with or coupled to a display 1150 positioned on the handlebars 1148. It is also contemplated that the sensor 1146 and/or display 1150 may be coupled to the stem 1152. The sensor 1146 may include an antenna, which may be coupled directly to the sensor 1146 or indirectly, e.g., via a wired or wireless connection. The safety device 1142 may be coupled to the battery 1144 as described in detail above. In this embodiment, the safety device 1142 includes a connectivity module. The safety device 1142 may also include a BMS circuit (or the BMS circuit may be a separate component). The safety device 1142 may be positioned inside the battery housing cavity (e.g., as described with respect to FIG. 17).

The sensor 1146 may be coupled to the display 1150. For example, the sensor 1146 may be coupled to the display 1150 electronics. The display 1150 may be part of a bicycle computer, a user device, or a dedicated user device. It is contemplated that the sensor 1146 may be coupled to the handlebars 1148. As an example, the sensor antenna may be an LDS antenna printed into the handlebars 1148 (e.g., in the stem 1152).

The display 1150 may be coupled to the battery 1144 by a battery power line 1154 (e.g., a power cable or wire). The battery power line 1154 may be removably coupled to the battery 1144 and/or display 1150, e.g., enabling the display 1150 to be removed. As an example, the battery 1144 may include a USB port for removably coupling the battery power line 1154. The sensor 1146 (and/or its antenna) may be coupled to the safety device 1142 by the battery power line 1154 for power and may pass data/signals to the safety device 1142 via the battery power line 1154. The placement of the sensor 1146 and/or the sensor antenna on the handlebars 1148 may enhance signal strength and performance of the safety device 1142. It is also contemplated that the sensor 1146 and/or the sensor antenna may be coupled to the safety device 1142 by wireless means or other dedicated data cables.

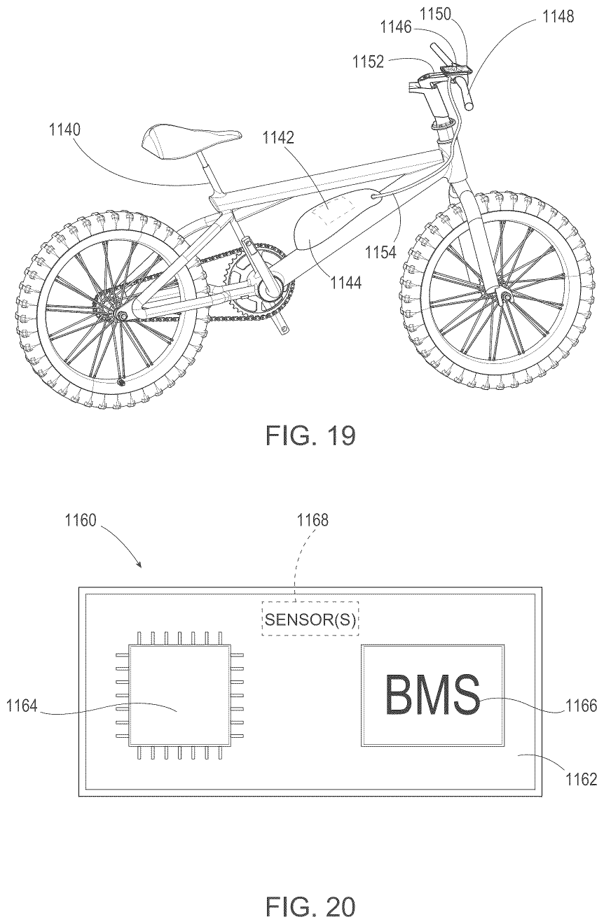

FIG. 20 is a top plan view of an exemplary safety device 1160 that is configured to couple with a light mobility vehicle battery. The safety device 1160 includes a printed circuit board 1162, one or more connectivity modules 1164, and a BMS circuit 1166. The safety device 1160 may include one or more sensors 1168. The one or more sensors 1168 may be coupled to the one or more connectivity modules 1164. The safety device 1160 may be coupled to a battery of a light mobility vehicle or its own battery. The safety device 1160 can include additional sensors (not shown), which are separate from main components of the safety device 1160 shown in FIG. 20. For example, the safety device 1160 can include one or more additional sensors positioned on the handlebars of a light mobility vehicle, where the one or more additional sensors are connected (via wires or wirelessly) to the one or more connectivity modules 1164 or the printed circuit board 1162.

While the safety device is described in various embodiments herein with respect to a battery of a light mobility vehicle, it is contemplated that the safety device may be coupled to other light mobility vehicle components or parts (e.g., controllers, display, motor, transmission, etc.) in a similar manner. For example, other light mobility vehicle electronics may be coupled to the PCB of the safety device (or the one or more connectivity modules and/or one or more sensors otherwise incorporated into existing electronics of the light mobility vehicle). It is contemplated that the safety device may include one or more specialized antennas to mitigate interference from such existing electronics or one or more antennas may be positioned external to the light mobility vehicle component or part and in communication with the safety device, as described above.

For example, the safety device, or components thereof, may be positioned on, partially within, or within a controller (e.g., a motor controller) of a light mobility vehicle. It is contemplated that the safety device may be positioned on or at least partially within a controller in any of the various positions and arrangements as described above with respect to the positioning of the safety device relative to the battery (e.g., on the top or upper wall of the controller housing, inside the housing with an antenna positioned on an outer wall, e.g., top wall, of the controller housing, or the like as described in detail above). A controller may be used to connect electrical components of a light mobility vehicle together, including, for example, the battery, motor, throttle, display, pedal-assist, and the one or more sensors. The controller may transmit power from the battery to the motor and may control the speed of the light mobility vehicle based on input from the throttle. Exemplary controllers include brushless DC motor controllers, brushed DC motor controllers, and BLDC controllers (e.g., for motors with Hall sensors).

The controller may have a controller housing and a controller circuit board that includes a controller circuit. The controller may have other conventional controller components. It is contemplated that the controller housing may be omitted, for example because the controller is contained within another housing, like the battery housing or safety device housing, or is contained within the bike frame. Like other electrical components, the controller needs to be contained within something to keep it free of dirt, other debris, and water. In some embodiments, the controller circuit board and/or other controller components are integrated with the safety device. For example, the controller circuit board and/or other controller components may be positioned inside the safety device housing. In some embodiments, the controller circuit is coupled to the safety device printed circuit board, e.g., in a similar manner as described with respect to the BMS circuit. In some embodiments, the safety device or its components are positioned inside the controller housing with the controller components. In some embodiments, the safety device or its components are coupled to the controller circuit board. For example, the safety device printed circuit board may be omitted and the safety device components may be coupled to the controller circuit board. In some embodiments, the safety device or its components, the controller components (e.g., the controller circuit board or circuit), and the BMS circuit board or circuit may be housed in the same location (e.g., inside the safety device housing, the battery housing, or the controller housing) or coupled to the same circuit board (e.g., the safety device printed circuit board, the BMS circuit board, or the controller circuit board).

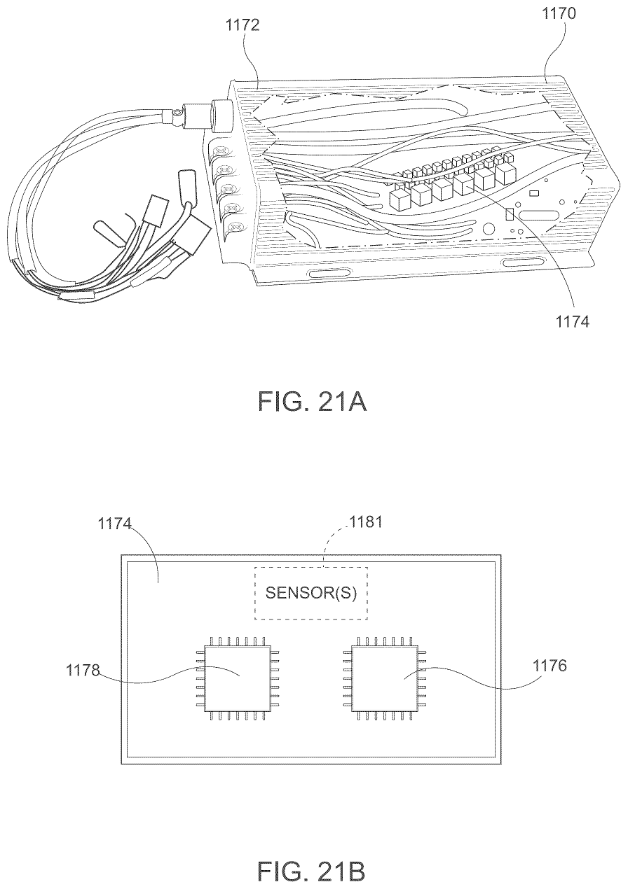

FIGS. 21A-B show images of an exemplary controller that incorporates safety device components. As shown in FIG. 21A, the controller 1170 includes a housing 1172 and a controller circuit board 1174 contained within the housing 1172. A portion of the housing 1172 is removed for illustration purposes only to show the internal components within the housing 1172. FIG. 21B shows a simplified diagram of the controller circuit board 1174. As shown, the controller circuit board 1174 includes a controller circuit 1176 and safety device components, including one or more connectivity modules 1178. The controller circuit 1176 may include one or more sensors 1181 in communication with the one or more connectivity modules 1178.

The controller housing may be coupled to the light mobility vehicle, e.g., in any of the various positions on the light mobility vehicle as described above with respect to the positioning of the battery relative to the light mobility vehicle. It is contemplated that the controller may be positioned inside of the light mobility vehicle frame (e.g., in the down tube, in the handlebar stem, etc.) and hidden from view. In some embodiments, the controller is integrated with a bicycle computer or display (e.g., of a dedicated user device). It is contemplated that the controller may be coupled to an ebike in conventional locations.

In several embodiments, the safety device may utilize existing connectors (e.g., wires, cables, existing wireless communication devices, etc.) of a light mobility vehicle to transmit data and signals. For example, as discussed above, the safety device may use a power cable or power supply line (e.g., +36V/GND) connected to the battery to receive power and transmit data/signals when the safety device or its components are coupled to the battery. As another example, the safety device may use electrical cables coupled to the controller to transmit data and signals. As yet another example, the safety device may use cables coupled to the gear shift or derailleur to transmit data and signals. Additionally or alternatively, the safety device may transmit data and signals wirelessly. The data/signals transmitted may include, for example, GPS NMEA data, GPS NMEA sentences, Xyz indication, LTE data, and the like. These examples of data transmission over existing light mobility connectors are meant to be exemplary and other existing connectors may be used to transmit data and signals between safety device components and, in some instances, between the safety device components and other light mobility vehicle components (e.g., BMS circuit, controller, etc.).

### Light Mobility Vehicle Safety Systems

In several embodiments, a safety system for a light mobility vehicle is disclosed that includes the safety device coupled to the light mobility vehicle according to any of the various embodiments described above. The safety system may include the one or more sensors and/or one or more antennas as integrated components of the safety device or as separate components from the safety device and in communication with the safety device by wired or wireless means. As described above, the safety system may utilize existing light mobility vehicle components to power the safety system components and transmit data and signals between the safety system components. The safety system may inject a modulated carrier signal into the light mobility vehicle wiring system to operate power-line communications between safety system components.

FIG. 22 shows an image of an exemplary light mobility vehicle safety system, specifically, a micromobility vehicle (MV) safety system 1012 integrated with a bicycle 1014. The MV safety system 1012 may be part of safety system 100 described herein. As shown, the MV safety system 1012 includes a safety device 1016, a user device 1018, and a sensor device 1020. The safety device 1016, user device 1018, and sensor device 1020 may be any of the various devices described herein, for example, safety device 800, a dedicated user device described herein, and sensor device 930 or 952. In the depicted embodiment, the safety device 1016 is positioned near the base of the bicycle 1014 between the wheels 1021a,b, the user device 1018 is positioned on a front end of the bicycle 1014, and the sensor device 1020 is positioned on a rear end of the bicycle 1014. Specifically, the safety device 1016 is positioned on the down tube 1022, the user device 1018 is positioned on the handlebars 1024, and the sensor device 1020 is positioned on the seat post 1026 below the seat 1028. It is contemplated that one or more of the safety device 1016, user device 1018, and sensor device 1020 may be omitted from the MV safety system 1012. In some embodiments, e.g., where the safety device 1016 is omitted, the user device 1018 may be configured to execute the same logic as safety devices described herein. For example, the user device 1018 may transmit and receive safety-related data (e.g., BSM such as position, speed, heading, etc.) to and from other system 100 devices (e.g., one or more user devices 106 or automotive vehicle connectivity devices 104) via network 110. The user device 1018 may execute one or more of the methods described herein to determine whether the safety-related data (e.g., BSM) received is indicative of a safety risk or threat.

As discussed above, the safety device 1016, user device 1018, and sensor device 1020 may include one or more sensors. For example, the user device 1018 may include a camera that is front-facing on the bicycle 1014 and the sensor device 1020 may include a camera that is rear-facing on the bicycle 1014, providing improved visibility to the micromobility vehicle (e.g., for object detection and risk/threat assessment around the micromobility vehicle). One or more of the safety device 1016, user device 1018, and sensor device 1020 may include one or more side-facing cameras that are facing the right or left sides of the micromobility vehicle. The side-facing cameras may enable a user of the micromobility vehicle to see if an entity is approaching or turning from a side of the micromobility vehicle. While the above example is described with respect to a micromobility vehicle, it is contemplated that the same features of the MV safety system 1012 may be included on another light mobility vehicle, such as, for example, a motorcycle, moped, ATV, etc.

FIG. 23 is a simplified block diagram of a light mobility vehicle safety system 1030 that can be integrated with a light mobility vehicle. As shown, the light mobility vehicle safety system 1030 includes a safety device 1032, a user device 1034, and a sensor device 1036. The safety device 1032, user device 1034, and sensor device 1036 may be any of the various devices described herein, for example, safety device 800, a dedicated user device described herein, and sensor device 930 or 952. As shown, the safety device 1032 may be in communication with one or more external sensors 1038 (e.g., a camera, accelerometer, LIDAR, thermometer, light, etc.). As shown, the safety device 1032 communicates with the user device 1034 and with the sensor device 1036 via BLE and/or Wi-Fi. In embodiments where external sensors 1038 are included, the safety device 1032 may communicate with the external sensors 1038 via BLE/ANT+. The sensor device 1036 may communicate with the user device 1034 via Wi-Fi and/or BLE. The light mobility vehicle safety system 1030 is intended for illustrative purposes and other communication protocols are contemplated between the various devices.

In several embodiments, the user device 1034 receives feedback from the safety device 1032 and sensor device 1036 related to safety risks or threats. For example, the sensor device 1036 may transmit streaming video data to the user device 1034. For example, sensor device 930 may be mounted on a bicycle such that the camera 936 is rear-facing and captures video of the environment behind the bicyclist. As discussed above, the sensor device 930 may process the image data and determine whether an object is a threat. If the sensor device 930 determines the object is a threat, the sensor device 930 may transmit an alert to the user device 1034. The sensor device 930 may transmit the threat data (e.g., the type of threat and location) to the cloud for storage. The cloud or remote processing element may map the threat (e.g., type and location) to a map interface and transmit the mapped threat to other user devices 106 in the system 100 (shown in FIG. 1).

In some embodiments, safety device components may be integrated with one or more other components of a light mobility vehicle safety system. For example, safety device components may be integrated with a user device, display, light mobility computer (e.g., bicycle computer), or sensor device. As an example, a light mobility computer may include one or more connectivity modules. For example, a bicycle computer, display, or dedicated user device may include one or more of Wi-Fi, BLE, and ANT+. Additionally or separately, the bicycle computer, display, or dedicated user device may include LTE. In some embodiments, the bicycle computer, display, or dedicated user device includes C-V2X. The bicycle computer, display, or dedicated user device may include one or more feedback components and/or one or more input components. For example, the bicycle computer or dedicated user device may include a display and/or microphone. For example, the display may be a 3.2″ TFT with local resistive buttons. In some embodiments, the bicycle computer, display, or dedicated user device includes a sensor, such as a camera or GNNS sensor. The bicycle computer, display, or dedicated user device may couple to bicycle handlebars. As an example, the bicycle computer, display, or dedicated user device may be coupled to or integrated with the stem of a bicycle.

In some embodiments, a safety device described herein may be portable and may be carried by a user, e.g., in a purse or backpack. For example, a disclosed safety device may be placed in a child's backpack to increase the child's awareness of others and others' awareness of the child. As another example, a safety device may be placed in a vehicle (e.g., car or bus) that has no embedded connectivity devices (e.g., is not C-V2X or modem equipped). In this example, the safety device may be in communication with the vehicle's sensors (e.g., via wireless communication). In this example, the non-embedded or portable safety device enables the vehicle to connect with other system IoT devices. Further, the driver could take the safety device out of the vehicle and carry it to remain connected to the system, enabling others to remain aware of the driver even when the driver is not in the car. The user could also take the safety device from his/her vehicle and use it in another vehicle, e.g., a different light mobility vehicle or other vehicle. Current systems do not allow for such expansive connectivity.

In some embodiments, the portable safety device may be paired with a light mobility vehicle, including, for example, a third-party light mobility vehicle. Third-party light mobility vehicles may include, for example, shared electric scooters and bikes (e.g., Lime, Lyft, etc.). The portable safety device may be paired with a light mobility vehicle via a Bluetooth connection or other communication protocol. In some embodiments, the portable safety device may be paired with a light mobility vehicle by scanning a bar code on the light mobility vehicle. In some embodiments, the portable safety device may be coupled to the light mobility vehicle by a wire or cable. The portable safety device may communicate with one or more processors and/or one or more sensors of the light mobility vehicle. The portable safety device may exchange entity data and/or alerts with the light mobility vehicle. For example, the portable safety device may transmit an alert to the light mobility vehicle when a threat is determined (e.g., it may flash a light mobility vehicle light or transmit a visual alert to a display on the light mobility vehicle). In some embodiments, the portable safety device may instruct the light mobility vehicle to slow down or stop.

In some embodiments, the portable safety device may receive entity data or sensor data from the light mobility vehicle (e.g., from the sensors). The portable safety device may aggregate the entity data received with entity data received directly (e.g., via C-V2X) to determine more accurate entity data. The portable safety device may determine a trajectory of the light mobility vehicle based on sensor data received to improve risk assessment. For example, the portable safety device may receive a right turn signal from the light mobility vehicle and entity data directly (e.g., via C-V2X) that indicates a trajectory of another entity and determine a high likelihood of collision.

In several embodiments, a disclosed safety device may share data with other connectivity devices, user devices, and/or sensors associated with or coupled to a light mobility vehicle to improve connectivity with other entities or road users and/or to improve the ability of the light mobility vehicle to detect its surroundings, and specifically to detect threats. As an example, a user device may include a safety application (e.g., as described in the PCT Application) that executes the methods described herein and in the PCT application. In this manner, the user device may function in a similar manner as a disclosed safety device. The user device may communicate with other entities by a cellular modem (and through a server) and may receive entity data from those entities (e.g., related to their position, speed, direction, trajectory, etc.). The safety device may receive, via its one or more connectivity modules, entity data from other entities. The safety device may receive the entity data received by the user device and may compare, via its local processing element, the entity data received by the user device to the entity data received directly by the safety device. Alternatively, the entity data received by the user device and the entity data received by the safety device may be transmitted to the server and processed remotely. The entity data may be compared to reconcile differences in the data and to generate more accurate data. It is contemplated that one or more sensors coupled to the light mobility vehicle may receive sensor data and transmit the sensor data to the safety device for local processing or to the server for remote processing. This sensor data may be compared to the entity data received by the safety device, and in some embodiments, to the entity data received by the user device, to improve the accuracy of the data.

In the example of a motorcycle or a car, the safety device may exchange data with one or more ADAS sensors to improve visibility around the motorcycle or car. The safety device may be coupled to the one or more ADAS sensors by a CAN bus or other wired or wireless connection. The safety device may receive data from the one or more ADAS sensors related to turn signaling, braking, acceleration/deceleration, wheel angle, and the like. Such data may be analyzed by the safety device processor to determine a trajectory of the motorcycle or car. For example, the safety device processor may determine the motorcycle or car is turning right based on signal data received from a right turn blinker. The safety device may receive entity data from other entities (e.g., via its one or more connectivity devices) and compare the entity data received to the sensor data received from the one or more ADAS sensors to determine a threat (e.g., whether a trajectory of the car or motorcycle intersects with a trajectory of the other entity that is likely to result in a collision).

The sensor device may transmit an alert based on the threat, as discussed in more detail above and in the PCT Application. In this manner, the safety device may improve the capabilities of an ADAS system of a motorcycle, car, bus, garbage truck, or other vehicle by providing additional threat detection and alerts related thereto. For example, a typical ADAS system may have surround view, park assist, blind spot detection, rear collision warning, cross traffic alert, traffic sign recognition, lane departure warning, emergency braking, adaptive cruise control, and the like. The safety device may add additional alerts, including, for example, do not pass, left/right turn assist (e.g., do not turn), and additional surround view, park assist, rear collision warning, and blind spot detection capabilities. The safety device processor may compare data received from the one or more ADAS sensors to entity data received by the one or more connectivity modules of the safety device to reconcile differences in the data and provide more accurate safety-related data (e.g., data related to the car or motorcycle's surroundings). In this manner, the safety device may improve the accuracy of a car or motorcycle ADAS system.

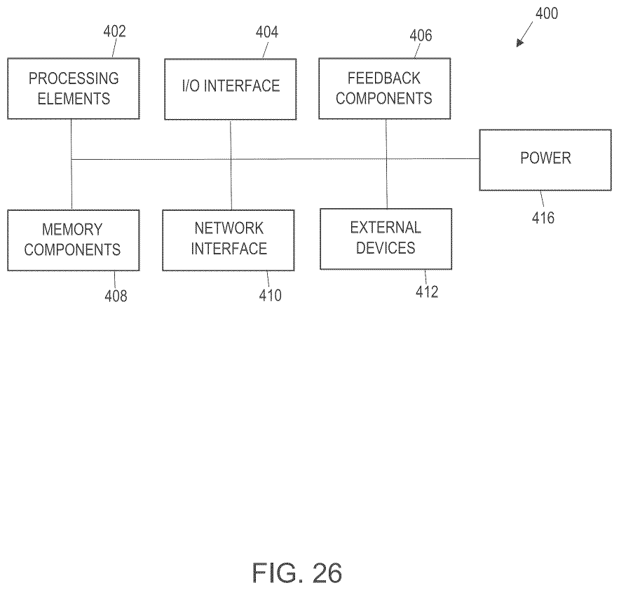

FIG. 27 is a simplified block diagram of a safety system of a motor vehicle. As shown, the motor vehicle safety system 1400 includes an ADAS system 1402 and a safety device 1404 in communication with the ADAS system 1402. The motor vehicle may be an automotive vehicle (e.g., a car) or motorized light mobility vehicle (e.g., a motorcycle). The ADAS system 1402 may include ADAS sensors 1406, an ADAS processor 1408 that executes ADAS logic, and a human-machine interface (HMI) 1410. The safety device 1404 may communicate with one or more of the ADAS sensors 1406, ADAS processor 1408, and HMI 1410. For example, the safety device 1404 may receive entity data from one or more ADAS sensors 1406. The safety device 1404 may compare the entity data received from the one or more ADAS sensors 1406 to entity data received directly (e.g., via C-V2X) to determine whether a new threat is detected or the entity data received directly is accurate. For example, the safety device 1404 may not sense an object that is detected by a camera. The safety device 1404 may correct errors in the entity data received directly or otherwise improve upon the logic executed by its processor based on discrepancies in the entity data received. For example, the safety device 1404 may learn of new safety risks and use this data to make better risk assessments.

As another example, the one or more ADAS sensors 1406 may receive entity data from the safety device 1404. The entity data received may assist the ADAS sensors 1406 in more accurate or efficient object detection or other sensing functionality. For example, the safety device 1404 may detect an entity that is out of view of the ADAS sensors 1406 and undetectable by them. The safety device 1404 may transmit this entity data to the ADAS sensors 1406 to focus their attention on the entity. For example, the safety device 1404 may detect a high probability of an entity at a particular location (e.g., via C-V2X) and transmit this location data to a camera of the ADAS system 1402 such that the camera can aim towards that location to confirm the entity is there. By focusing on a particular location instead of looking everywhere, the camera can be more efficient at object detection.

As yet another example, the ADAS processor 1408 may receive entity data, threat data, and/or alerts from the safety device 1404. The ADAS processor 1408 may receive data from the ADAS sensors 1406 and aggregate, compare, and otherwise analyze the data for threats or safety risks. The ADAS processor 1408 may aggregate the additional entity data received from the safety device 1404 to determine whether there are undetected threats or otherwise assess the accuracy of the data collected by the ADAS sensors 1406. The ADAS processor 1408 may learn of new safety risks or threats from the entity data received from the safety device 1404 and improve its logic to perform better risk assessment. The ADAS processor 1408 may receive threat data or alerts from the safety device 1404 and may transmit an alert to the HMI. The ADAS processor 1408 may instruct an ADAS sensor 1406 to focus on the location of the threat to assess the accuracy of the threat.

In some embodiments, the ADAS processor 1408 may transmit entity data and/or threats and alerts to the safety device 1404. As discussed, the ADAS processor 1408 may receive entity data from the ADAS sensors 1406 and may determine, based on this data, threats or safety risks. The safety device 1404 may incorporate this data into its risk assessment logic. For example, the safety device 1404 may aggregate or compare the entity data or threat data to the entity data received directly (e.g., via C-V2X) or the threat data determined by the safety device processor, respectively, to determine more accurate or robust entity data or threat data. The safety device 1404 may correct errors in the entity data received directly or determined threat data or otherwise improve upon the logic executed by its processor based on discrepancies in the data received. For example, the safety device 1404 may learn of new threats and use this data to make better risk assessments.

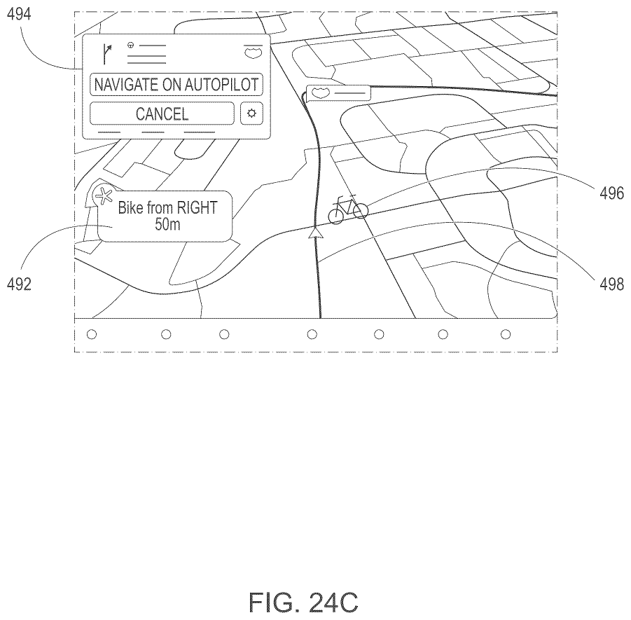

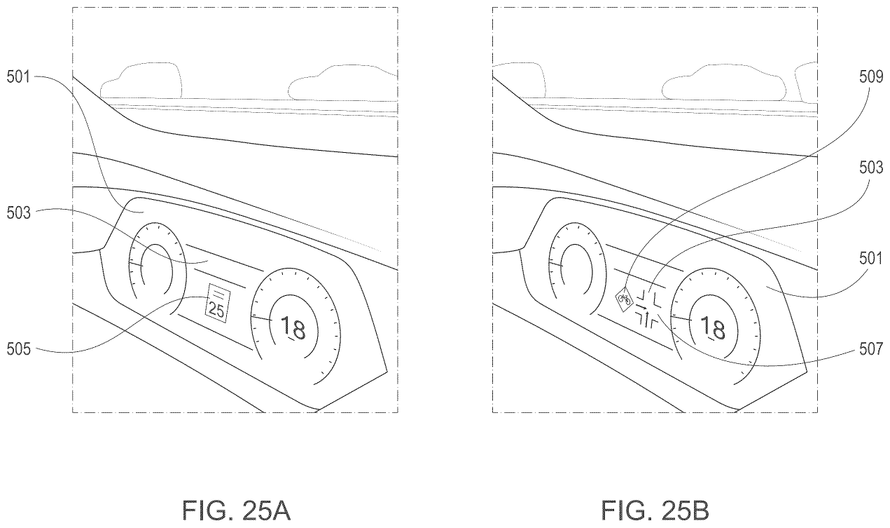

In some embodiments, the safety device 1404 may transmit alerts or warnings to the HMI 1410. The HMI 1410 may be a GUI on a display in a car (e.g., see FIGS. 24A-C and FIG. 25A-D) or on a head unit of a motorcycle, or the like. The alert may be any of the alerts described herein or in the PCT Application. For example, the alert may be an icon or warning message. The alert may include visual, haptic, and/or audible feedback. In some embodiments, the safety device 1404 may instruct the ADAS sensors 1406 or ADAS processor 1408 to brake the vehicle.

### Application of Safety-Related Data

Safety-related data collected, determined, and transmitted by the safety devices and systems described herein is more robust than data previously available to road users, providing increased safety and visibility of others. As described in detail in the PCT Application, such data may be available to light mobility vehicle users, automotive vehicle users, and pedestrians by a display associated with a safety device, with a dedicated user device, or other user device.

In some embodiments, a safety device and/or the safety-related data described herein may be incorporated or integrated into an automotive vehicle. For example, a portable safety device may be placed in an automotive vehicle that is without connectivity capabilities. Note that the discussion in paragraphs [0136]-[0142] applies here and is not repeated here in order to reduce repetition. Such portable safety device may include a display for providing feedback to a user or may be in communication with the vehicle's onboard display(s). As another example, a portable safety device may be placed in an automotive vehicle and may provide additional connectivity to the vehicle. For example, the vehicle may already have C-V2X technology integrated and the safety device may improve visibility of safety hazards by providing additional safety-related data from the cloud (and aggregating the remote safety-related data with the local data) and/or providing other connectivity capabilities (e.g., LTE). Additionally, the portable safety device may communicate with other safety devices and relay that information to the automotive vehicle.

For example, a safety device may be placed in a car glove compartment and may be in communication with a car display to display relevant safety-related data. In some embodiments, a safety device disclosed herein may be omitted and the logic executed by safety devices described herein may be included in a chip or SIM card or other simplified hardware architecture that can be integrated into a vehicle for operation with the vehicle's integrated hardware and software. For example, a safety application may be installed on a car computer to execute the safety methods described herein and in the PCT Application.

In some embodiments, safety-related data is received and processed by an automotive vehicle (e.g., by one or more automotive vehicle processors) and displayed on a graphical user interface associated with the automotive vehicle. An automotive vehicle processor may integrate the safety-related data into existing algorithms or execute disclosed algorithms that utilize safety-related data, as described herein and in the PCT Application. The one or more automotive vehicle processors may receive automotive vehicle sensor data from one or more automotive vehicle sensors. The automotive vehicle sensor data may be combined with entity data received from a nearby entity to assess a threat, as described in more detail below.

In several embodiments, safety-related data may be displayed on a dashboard display or on a center stack display of an automotive vehicle. For example, an automotive vehicle display may provide consolidated, useful information to a user, such as, for example, information on approaching entities (e.g., the type of entity that is approaching, number of entities within a short-distance range, an approximate distance, speed, direction, etc. of one or more entities, and the like) and alerts related thereto.

FIGS. 24A-C are images showing exemplary graphical user interfaces (GUIs) for automotive vehicle center stack displays, which display maps that integrate the safety-related data described herein. FIG. 24A is an image of a GUI 162b on an automotive vehicle center stack display 160b that depicts a map with route information. FIG. 24B is an image of a graphical user interface 160d of an automotive vehicle center stack display that depicts a map displaying an exemplary alert. In the depicted embodiment, the alert is displayed as a bar that overlays the map; however, other ways of displaying alerts are contemplated. For example, alerts may be integrated into the map layer. As another example, alerts may be text boxes that display important messages or notifications. The depicted alert is a safety information bar that displays various icons, including a car icon 163a at the top of the bar that represents the entity associated with the graphical user interface 160d and a bicycle icon 165a that represents a nearby entity. The bicycle icon 165a is below an arrow that points towards the car icon 165a showing a bicycle is approaching the car. The GUI 160d also displays another entity's route 169a. For example, the other entity route 169a may be a planned route of a cyclist within a certain distance range to the car. For example, the planned route may be stored as data within a safety application or third-party application on a user device associated with the other entity, and such data may be shared, via the server, with the car and displayed on the GUI 160d. For example, the cyclist may be using a navigation or exercise application (e.g., Google Maps, Waze, Strava) to guide her ride. The navigation or exercise application can share the planned route with the cyclist's safety device and/or the motor vehicle's safety device. By displaying other entity routes, the safety application displayed on the GUI 160d may help the user better avoid collisions with the other entities. Similarly, if the driver of the motor vehicle is using a navigation application, that information can be shared with the motor vehicle's safety device and/or the cyclist's safety device to further improve collision detection and prevention.

The map displayed on the automotive vehicle GUI may be part of a dedicated safety application, as described in more detail in the PCT Application, or a map from a third-party application (e.g., a fitness or navigation application). As an example, alerts may overlay a third-party map when a third-party application is open on the GUI and displaying third-party data. In this manner, a user may view other applications and still receive important data (e.g., safety-related data), such as, for example, data on approaching entities. As another example, safety-related data may be embedded into a third-party mapping layer and consistently displayed while the third-party application is open. As yet another example, a dedicated safety application may be open and displayed on the GUI that displays information described herein (e.g., safety-related data, routes, alerts, etc.).

FIG. 24C shows a zoomed-in view of an exemplary GUI that can be displayed on an automotive vehicle display. The GUI 494 displays a map with route information, entity information, and safety-related alerts described herein. The map may be a map of a dedicated safety application or a third-party application. The GUI 494 displays an alert notification 492 and an entity icon 496 on the map interface. The entity icon 496 indicates the location of another entity, the direction the other entity is traveling, and the type of entity. As shown, a bicycle entity icon 496 is displayed on the map interface coming from a direction to the right of the user's route 498. In this example, the alert notification 492 indicates that a bicycle is approaching the user from the right 50 m away.

FIGS. 25A-D show images of an automotive vehicle dashboard display displaying safety-related messages and alerts. The figures show a sequence of images of a car display 501 displaying an exemplary safety application interface 503 that displays varying data on an approaching entity based on the entity's position relative to the driver. FIG. 25A shows the safety application interface 503 on the car display 501 displaying relevant road information to a driver. In the depicted example, the safety application interface 503 displays traffic signs, specifically, the relevant speed limit sign 505. When a threat is detected (e.g., an entity is in proximity that has a high collision probability with the driver based on each entity's direction, heading, speed, acceleration, trajectory, etc.), the safety application interface 503 displays relevant information related to the threat. The threat may be detected based on data received from a C-V2X chip or cellular modem installed in the car or based on data received by a safety application installed in the car or on a user device in communication with the car computer.

As shown in FIG. 25B, the safety application interface 503 displays threat information as an intersection icon 507 showing an entity icon 509 and its position relative to the intersection and to the driver. As shown, the entity is approaching the intersection from the left of the driver. As shown, the entity icon 509 and threat are displayed on the safety application interface 503 before the entity is visible to the driver. As shown in FIG. 25C, the safety application interface 503 continues to display the entity icon 509 as the driver approaches the entity 511 (in this case, a cyclist). In the depicted example, as the threat becomes greater, meaning more imminent or more likely, (e.g., based on the proximity of the entity 511 to the driver or the driver approaching an estimated collision point), the safety application interface 503 displays a more prominent alert. As shown in FIG. 25D, the safety application interface 503 displays a proximity or collision icon 513 indicating the threat is imminent. The entity icon 509 may be displayed differently to show an increased threat level (e.g., the entity icon 509 may be displayed in a different color). The alert may include an audio or haptic alert. For example, the car computer may play a sound or vibrate a component of the vehicle (e.g., the steering wheel) when the alert is displayed.

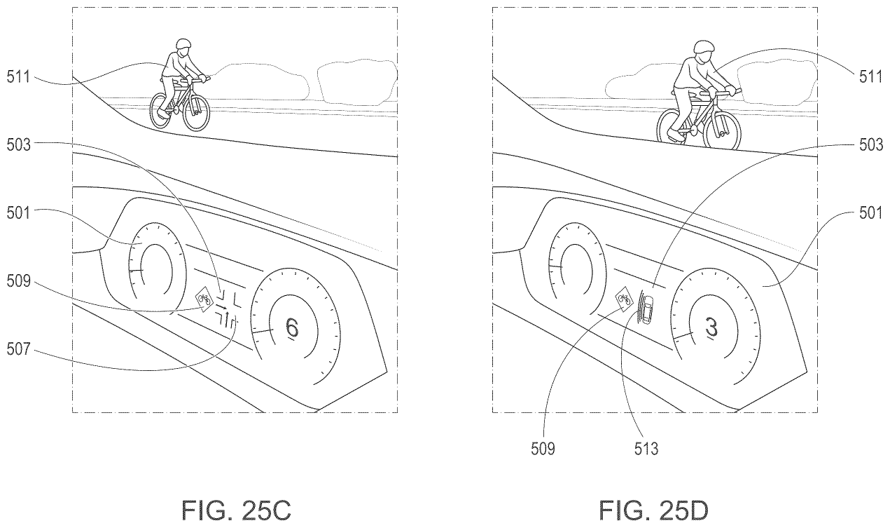

A simplified block structure for computing devices 400 that may be used with the system 100 or integrated into one or more of the system 100 components is shown in FIG. 26. For example, the safety device(s) 102, automotive vehicle connectivity device(s) 104, user device(s) 106, and/or server(s) 108 (shown in FIG. 1) may include one or more of the components shown in FIG. 26 and be used to execute one or more of the operations disclosed in methods 1250, 1300, and 1350. With reference to FIG. 26, the computing device 400 may include one or more processing elements 402, an input/output interface 404, feedback components 406, one or more memory components 408, a network interface 410, one or more external devices 412, and a power source 416. Each of the various components may be in communication with one another through one or more busses, wireless means, or the like.

The local processing element 402 is any type of electronic device capable of processing, receiving, and/or transmitting instructions. For example, the local processing element 402 may be a central processing unit, microprocessor, processor, or microcontroller. Additionally, it should be noted that select components of the computing device 400 may be controlled by a first processor and other components may be controlled by a second processor, where the first and second processors may or may not be in communication with each other and may or may not be the same type of processor.

The one or more memory components 408 are used by the computing device 400 to store instructions for the local processing element 402, as well as store data, such as the entity data, third-party database entity data, light mobility vehicle data, user data, environmental data, collision-related data, and the like. The one or more memory components 408 may be, for example, magneto-optical storage, read-only memory, random access memory, erasable programmable memory, flash memory, or a combination of one or more types of memory components.

The one or more feedback components 406 provide visual, haptic, and/or auditory feedback to a user. For example, the one or more feedback components may include a display that provides visual feedback to a user and, optionally, can act as an input element to enable a user to control, manipulate, and calibrate various components of the computing device 400. The display may be a liquid crystal display, plasma display, organic light-emitting diode display, and/or cathode ray tube display. In embodiments where the display is used as an input, the display may include one or more touch or input sensors, such as capacitive touch sensors, resistive grid, or the like. As another example, the one or more feedback components 406 may include a light (e.g., LED), an alarm or alert sound, a vibration, and the like.

The I/O interface 404 allows a user to enter data into the computing device 400, as well as provides an input/output (I/O) for the computing device 400 to communicate with other devices (e.g., the safety device 102, one or more servers 108, other computers, etc.). The I/O interface 404 can include one or more input buttons or switches, remote controls, touch pads or screens, microphones, and so on. As an example, the I/O interface 404 may be one or both of a capacitive or resistive touchscreen.

The network interface 410 provides communication to and from the computing device 400 to other devices. For example, the network interface 410 allows the one or more servers 108 to communicate with the one or more user devices 106 through the network 110. The network interface 410 includes one or more communication protocols, such as, but not limited to Wi-Fi, Ethernet, Bluetooth, Zigbee, and so on. The network interface 410 may also include one or more hardwired components, such as a Universal Serial Bus (USB) cable, or the like. The configuration of the network interface 410 depends on the types of communication desired and may be modified to communicate via Wi-Fi, Bluetooth, and so on.

The external devices 412 are one or more devices that can be used to provide various inputs to the computing device 400, e.g., mouse, microphone, keyboard, trackpad, or the like. The external devices 412 may be local or remote and may vary as desired.

The power source 416 is used to provide power to the computing device 400, e.g., battery (e.g., graphene/zinc hybrid), solar panel, lithium, kinetic (e.g., energy harvested from a bicycle) or the like. In some embodiments, the power source 416 is rechargeable; for example, contact and contactless recharge capabilities are contemplated. In some embodiments, the power source 416 is a constant power management feed. In other embodiments, the power source 416 is intermittent (e.g., controlled by a power switch or activated by an external signal). The power source 416 may include an auxiliary power source.

### Methods

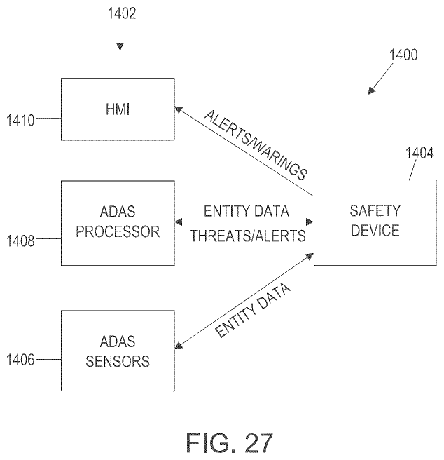

In several embodiments, methods of manufacturing a disclosed safety device are disclosed. FIG. 28 is a flow chart illustrating methods of manufacturing a disclosed safety device. Although FIG. 28 shows the operations in a specific order, the order of the operations can be switched depending on the specific application and needs of the manufacturer. The method 1250 begins with operation 1252, where one or more connectivity modules are coupled to a circuit board. The one or more connectivity modules may be any of the connectivity modules described herein, including, for example, a C-V2X module, a cellular modem (e.g., an LTE module), a BLE module, Wi-Fi module, ANT+ module, and the like. The one or more connectivity modules may be configured to transmit entity data to a nearby entity having a compatible connectivity module. A compatible connectivity module may use the same communication protocol as a connectivity module of the one or more connectivity modules. For example, a connectivity module that is compatible with a C-V2X module of a safety device includes a C-V2X module.

After operation 1252, the method 1250 may proceed to operation 1254 and one or more sensors may be coupled to the circuit board and/or to the one or more connectivity modules. The one or more sensors may be any of the sensors described herein, including, for example a GNSS sensor (e.g., a GPS sensor). The one or more sensors may be coupled directly to the circuit board or indirectly, e.g., via a wire or cable (e.g., a power cord as described with respect to FIG. 19) or wirelessly.

After operation 1254, the method 1250 may proceed to operation 1256 and the circuit board may be positioned inside a safety device housing. The safety device housing may have a form factor compatible with a component of a light mobility vehicle and may be configured to couple to the component. For example, the safety device housing may have a rectangular shape, for example to couple to an external component of a light mobility vehicle, e.g., to the down tube of a bicycle, battery, handlebars, stem, etc. As another example, the safety device housing may have a cylindrical shape, for example to be positioned inside a frame component, e.g., the seat tube or down tube of a bicycle. The safety device housing may protect the circuit board from external factors such as dirt and debris.

In some embodiments, the method 1250 may proceed to operation 1258 instead of operation 1256 and one or more controller circuit components may be coupled to the circuit board. After operation 1258, the method 1250 may proceed to operation 1260 and the circuit board may be positioned inside a safety device housing or a controller housing.

In some embodiments, the method 1250 may proceed to operation 1262 instead of operation 1256 and a BMS circuit may be coupled to the circuit board. After operation 1262, the method 1250 may proceed to operation 1264 and the circuit board may be positioned inside a safety device housing or a battery housing.

After operation 1256, or alternatively operations 1260 or 1264, the method 1250 may proceed to operation 1266 and one or more specialized antennas may be coupled to the one or more sensors and/or one or more connectivity modules. It is contemplated that the one or more specialized antennas may be coupled to the circuit board. In some embodiments, the one or more specialized antennas are coupled to an external surface of the safety device housing or other surface of the light mobility vehicle. The one or more specialized antennas may reduce interference and improve signal strength for the one or more sensors and/or one or more connectivity modules. For example, the one or more specialized antennas may reduce interference from one or more components of a light mobility vehicle part when the safety device is positioned within or coupled to the light mobility vehicle part (e.g., battery components when the safety device is positioned inside or proximate to or otherwise coupled to a battery).

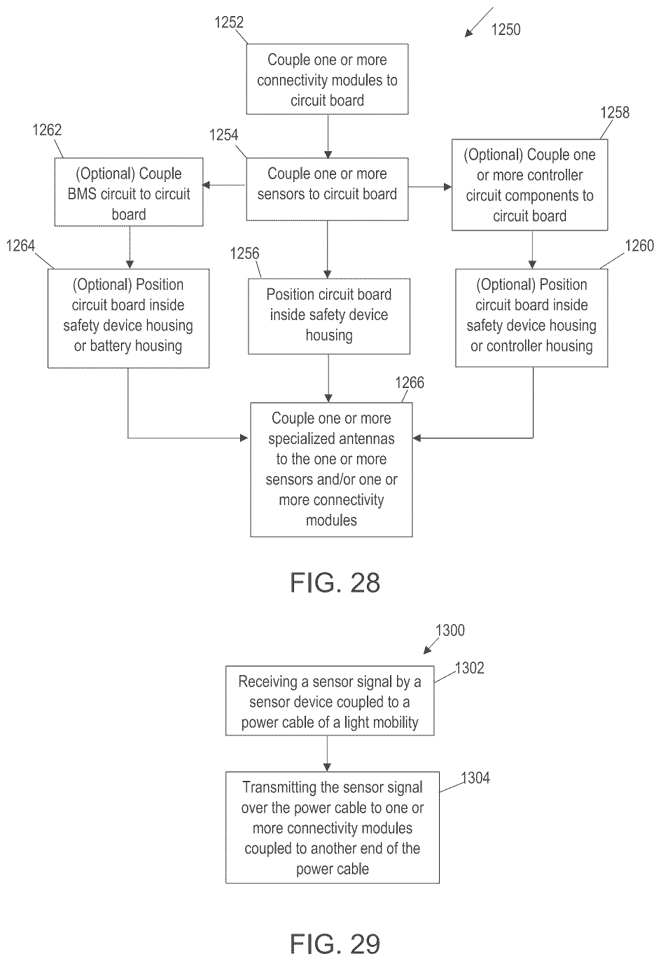

In some embodiments, a method of transmitting data across a light mobility vehicle power cable is disclosed. FIG. 29 is a flow chart illustrating a method of using a light mobility vehicle power cable to transmit a communication signal. The method 1300 begins with operation 1302 and a sensor signal is received by a sensor device coupled to a power cable of a light mobility vehicle. For example, a GNSS sensor may be coupled to a first end of a power cable and may receive a GNSS signal. FIG. 19, described in more detail above, shows an example of a sensor coupled to a power cable at a first end. As shown in FIG. 19, the sensor 1146 may be coupled to the display 1150 and/or to the handlebars 1148 (e.g., in the stem 1152). The sensor 1146 may be coupled to the battery power line 1154 for power and may pass data/signals therethrough.

After operation 1302 the method 1300 may proceed to operation 1304 and the sensor signal may be transmitted over the power cable to one or more connectivity modules coupled to another end of the power cable. For example, a GNSS signal may be transmitted to a C-V2X chip coupled to a second end of the power cable. The one or more connectivity modules may be coupled to a power source of the light mobility vehicle (e.g., a battery). As shown in FIG. 19, the battery power line 1154 may be coupled to the safety device 1142 (which includes the one or more connectivity modules) at the other end. The safety device 1142 may be coupled to the battery 1144 as described in detail above. In this manner, the sensor 1146 may be coupled to the safety device 1142 by the battery power line 1154 for power and may pass data/signals to the safety device 1142 via the battery power line 1154.

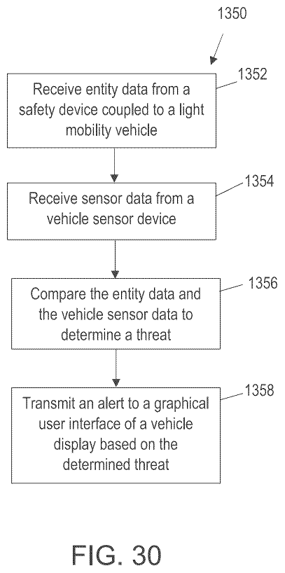

In several embodiments, a method of transmitting alerts of oncoming light mobility vehicles when a vehicle is traveling is disclosed. A vehicle is traveling when the vehicle is traveling on a route. It may be in motion or stopped (e.g., at a light or stop sign or when making a turn) when traveling on a route. FIG. 30 is a flow chart illustrating a method of transmitting alerts of oncoming light mobility vehicles when a vehicle is traveling. The method 1350 begins with operation 1352 and entity data related to a light mobility vehicle is received from a safety device coupled to the light mobility vehicle. The entity data may be received by an automotive vehicle processor coupled to an automotive vehicle. The entity data may be initially received by an automotive vehicle connectivity device coupled to or in communication with the automotive vehicle processor and transmitted by the automotive vehicle connectivity device to the automotive vehicle processor. The automotive vehicle connectivity device may be compatible with a connectivity device of the safety device. For example, the automotive vehicle connectivity device may be a C-V2X chip that is compatible with a C-V2X chip of the safety device. As another example, the automotive vehicle connectivity device may be a cellular modem that is compatible with a cellular modem of the safety device.

After operation 1352, the method 1350 may proceed to operation 1354 and vehicle sensor data may be received from one or more vehicle sensor devices. For example, automotive vehicle sensor data may be received by the automotive vehicle processor. Automotive vehicle sensor data or other vehicle sensor data may include, for example, a GPS signal, a turn signal, data related to speed, acceleration, deceleration, heading, braking, traction control, wheel angle, and the like.

After operation 1354, the method 1350 may proceed to operation 1356 and the entity data and vehicle sensor data may be compared and analyzed to determine a threat, for example a collision. For example, the entity data may include data related to a trajectory of the light mobility vehicle and the vehicle sensor data may include data related to a trajectory of the other vehicle (e.g., the automotive vehicle). A threat may be determined when the trajectories intersect and a high risk of collision is determined. For example, if the entity data received indicates the light mobility vehicle is headed in a straight path to the right of the automotive vehicle and at a particular speed, and the sensor data indicates the automotive vehicle is going to make a right turn at the next street (e.g., via a right turn signal), it may be determined that the automotive vehicle is likely to collide with the light mobility vehicle based on the light mobility vehicle's speed and direction and the location that the automotive vehicle will likely make the right turn.

After operation 1358, the method 1350 may proceed to operation 1358 and an alert may be transmitted to a graphical user interface of a vehicle display based on the determined threat. For example, the alert may be transmitted to an automotive vehicle display, as described in the paragraphs corresponding to FIGS. 24A-C and 25A-D. The alert may vary based on the threat level. For example, the alert may be more prominent or heightened if the threat is imminent, great, or high risk (e.g., greater than 90%, 91%, 92%, 93%, 94%, 95%, 96%, 97%, 98%, or 99%, etc. likelihood of collision) (e.g., louder, brighter, colored differently, flashing more, etc.). For example, if an automotive vehicle is about to turn and the light mobility vehicle is close, the alert may be more prominent to prevent an imminent collision. In some embodiments, the automotive vehicle processor may transmit a brake signal to an automatic emergency braking system of the automotive vehicle to brake the automotive vehicle.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated and may include electrical or wireless connection. As such, connection references do not necessarily infer that two elements are directly connected and/or in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

1. A safety device for a light mobility vehicle, comprising:
a circuit board positioned within or coupled to a light mobility vehicle part;
one or more connectivity modules coupled to the circuit board, wherein the one or more connectivity modules exchange entity data with one or more other entities; and
a specialized antenna coupled to the circuit board, wherein the specialized antenna is configured to mitigate interference of one or more components of the light mobility vehicle part with the one or more connectivity modules.

2. The safety device of claim 1, wherein the one or more connectivity modules comprise a C-V2X chip.

3. The safety device of claim 1, wherein the one or more connectivity modules comprise a cellular modem.

4. The safety device of claim 1, wherein the light mobility vehicle part is a battery and the specialized antenna mitigates interference from one or more battery components, improving signal strength of the one or more connectivity modules.

5. (canceled)

6. The safety device of claim 1, further comprising one or more sensors coupled to the circuit board, wherein the specialized antenna improves signal strength of the one or more sensors.

7.-8. (canceled)

9. A safety device for a light mobility vehicle, comprising:
a printed circuit board positioned inside a battery housing cavity defined by a battery housing of a battery coupled to the light mobility vehicle, wherein the battery comprises one or more battery cells positioned inside the battery housing cavity;
a first connectivity module coupled to the printed circuit board and to the one or more battery cells, wherein the first connectivity module is configured to communicate with a compatible other connectivity module that is separate from the light mobility vehicle and wherein the first connectivity module receives power from the one or more battery cells; and
one or more specialized antennas coupled to the printed circuit board or to the battery housing and in communication with the first connectivity module, wherein the one or more specialized antennas mitigate interference of one or more battery components with the communication between the first connectivity module and the compatible other connectivity module.

10. The safety device of claim 9, wherein the safety device further comprises a battery management system coupled to the printed circuit board and to the one or more battery cells.

11. The safety device of claim 9, wherein the first connectivity module comprises a C-V2X chip.

12. The safety device of claim 9, wherein the first connectivity module comprises a cellular modem.

13. The safety device of claim 11, further comprising a second connectivity module coupled to the printed circuit board, wherein the second connectivity module comprises a cellular modem.

14. The safety device of claim 9, wherein the one or more specialized antennas comprise an LDS antenna coupled to an external surface of the battery housing.

15. (canceled)

16. The safety device of claim 15, wherein the first connectivity module is in communication with a GNNS sensor that is positioned inside the battery housing and proximate a top wall of the battery housing.

17-27. (canceled)

28. A method of manufacturing a safety device for a light mobility vehicle, comprising:
coupling one or more connectivity modules to a circuit board, wherein the one or more connectivity modules are configured to transmit entity data to a nearby entity having a compatible connectivity module;
coupling one or more sensors to the one or more connectivity modules;
positioning the circuit board inside a housing, wherein the housing is a light mobility vehicle battery housing of a light mobility vehicle battery or a safety device housing configured to couple to a component of a light mobility vehicle; and
coupling an antenna to an external surface of the housing, wherein the antenna is coupled to the one or more sensors and is configured to reduce signal interference from the light mobility vehicle battery or the component.

29. The method of claim 28, wherein the one or more connectivity modules comprise a C-V2X chip.

30. The method of claim 29, wherein the one or more sensors comprise a GNNS sensor.

31. (canceled)

32. The method of claim 28, wherein coupling the one or more sensors to the one or more connectivity modules comprises coupling the one or more sensors to the one or more connectivity modules by a battery power cable of the light mobility vehicle, wherein the battery power cable permits communication between the one or more sensors and the one or more connectivity modules.

33. (canceled)

34. The safety device of claim 2, wherein the one or more connectivity modules further comprise a cellular modem.

35. The safety device of claim 4, wherein the one or more connectivity modules exchange basic safety messages with other entities without interference from the one or more battery components.

36. The safety device of claim 4, further comprising a GNSS sensor coupled to the one or more connectivity modules by a power supply line of the battery, wherein the GNSS sensor is configured to transmit a GNSS signal to the one or more connectivity modules via the power supply line.

37. The safety device of claim 1, further comprising a local processing element coupled to the circuit board and in communication with the one or more connectivity modules, wherein the local processing element is configured to assess a threat based the entity data received by the one or more connectivity modules from the one or more other entities.
